(19) United States
(12) Patent Application Publication
(10) Pub. No.: US 2018/0107992 A1
(43) Pub. Date: Apr. 19, 2018

(54) SOCIAL MEDIA PAYMENT PLATFORM APPARATUSES, METHODS AND SYSTEMS FOR PROCESSING PAYMENTS VIA SOCIAL MEDIA

(71) Applicant: VISA INTERNATIONAL SERVICE ASSOCIATION, San Francisco, CA (US)

(72) Inventor: Mohammad AL-BEDAIWI, San Francisco, CA (US)

(21) Appl. No.: 15/572,489

(22) PCT Filed: May 6, 2016
(86) PCT No.: PCT/US16/31289

§ 371 Date: Nov. 7, 2017

Related U.S. Application Data
(60) Provisional application No. 62/158,019, filed on May 7, 2015.

(51) Int. Cl. G06Q 20/08; G06Q 20/12; G06Q 20/32; G06Q 20/36; G06Q 50/00

(52) U.S. Cl. CPC G06Q 20/0855; G06Q 20/12; G06Q 50/01; G06Q 20/322; G06Q 20/367; G06Q 20/3255

(57) ABSTRACT

A computer-implemented method for processing payment requests via social media. Including receiving a payment request initiated by a payer via a social media network, including payer information associated with the payer and payee information associated with a payee. The method includes determining that the payer information is valid, generating an intent-to-pay notice associated with the payment request, and transmitting the intent-to-pay notice to a payee server associated with the payee based on the payee information. The method includes receiving a payment information request from the payee server. The payment information request includes information associated with the intent-to-pay notice. The method includes, in response to the payment information request, transmitting payment information to the payee server. The payment information allows the payee to process a payment associated with the payment request.

### CROSS-REFERENCE TO RELATED APPLICATIONS

This application claims priority to International Patent Application No. PCT/US2016/031289 entitled “SOCIAL MEDIA PAYMENT PLATFORM APPARATUSES, METHODS AND SYSTEMS FOR PROCESSING PAYMENTS VIA SOCIAL MEDIA,” filed May 6, 2016, which claims priority to U.S. Provisional Application Ser. No. 62/158,019, entitled “SOCIAL MEDIA PAYMENT PLATFORM APPARATUSES, METHODS AND SYSTEMS FOR PROCESSING PAYMENTS VIA SOCIAL MEDIA,” filed May 7, 2015, the entire contents of the which are expressly incorporated by reference herein. Other related applications are U.S. Provisional Application Ser. No. 61/423,588, filed Dec. 15, 2010, entitled “APPARATUSES, METHODS AND SYSTEMS FOR SECURE OFFERS, COMMERCE AND SERVICES ON SOCIAL NETWORKS”; U.S. Provisional Application Ser. No. 61/431,818, filed Jan. 11, 2011, entitled “APPARATUSES, METHODS AND SYSTEMS FOR A SOCIAL MEDIA PAYMENT PLATFORM”; U.S. Provisional Application Ser. No. 61/432,031, filed Jan. 12, 2011, entitled “APPARATUSES, METHODS AND SYSTEMS FOR A SOCIAL MEDIA PAYMENT PLATFORM”; U.S. Provisional Application Ser. No. 61/432,583, filed Jan. 13, 2011, entitled “APPARATUSES, METHODS AND SYSTEMS FOR A SOCIAL MEDIA PAYMENT PLATFORM”; U.S. Provisional Application Ser. No. 61/466,927, filed Mar. 23, 2011, entitled “APPARATUSES, METHODS AND SYSTEMS FOR A SOCIAL MEDIA PAYMENT PLATFORM”; and U.S. Provisional Application Ser. No. 61/467,302, filed Mar. 24, 2011, entitled “APPARATUSES, METHODS AND SYSTEMS FOR A SOCIAL MEDIA PAYMENT PLATFORM.” The entire contents of the aforementioned applications are expressly incorporated by reference herein.

This patent for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### BACKGROUND

Consumer transactions typically require a customer to select a product from a store shelf or website, and then to check out at a checkout counter or webpage. Product information is typically selected from a webpage catalog or entered into a point-of-sale terminal device, or the information is automatically entered by scanning an item barcode with an integrated barcode scanner, and the customer is usually provided with a number of payment options, such as cash, check, credit card or debit card. Once payment is made and approved, the point-of-sale terminal memorializes the transaction in the merchant's computer system, and a receipt is generated indicating the satisfactory consummation of the transaction.

### SUMMARY

The disclosure describes, in one embodiment, a computer-implemented method for processing payment requests via social media. The method includes receiving, via a digital communication network, a payment request including payer information associated with a payer and payee information associated with a payee. The payment request is initiated by the payer and communicated via a social media network. The method also includes determining, via one or more processors, that the payer information is valid. The method includes generating an intent-to-pay notice associated with the payment request, and transmitting, via a payment network, the intent-to-pay notice to a payee server associated with the payee based on the payee information. The method includes receiving, via the payment network, a payment information request from the payee server. The payment information request includes information associated with the intent-to-pay notice. The method also includes, in response to the payment information request, transmitting, via the payment network, payment information to the payee server. The payment information allows the payee to process a payment associated with the payment request.

In another embodiment, the disclosure describes a computer-implemented method for processing payment requests via social media. The method includes receiving, via a digital communication network, a payment request including payer information associated with a payer and payee information associated with a payee. The payment request is initiated by the payer and communicated via a social media network. The method includes determining, via one or more processors, that the payer information is valid, and transmitting, via the digital communication network, first confirmation information to a computing device associated with the payer. The method includes receiving, via a payment network, a payment information request from a payee server associated with the payee. The payment information request includes second confirmation information. The method also includes determining, via the one or more processors, that the first confirmation information matches the second confirmation information. Based on the determination that the first confirmation information matches the second confirmation information, the method includes transmitting, via the payment network, payment information to the payee server, wherein the payment information allows the payee to process a payment associated with the payment request.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIGS. 1A-B show block diagrams illustrating example aspects of payment transactions via social networks.

FIG. 2 is a flow chart of an embodiment of a process for receiving and executing payment requests via social media as shown and described herein.

FIG. 3 is a processing flow diagram of an embodiment of a process for receiving and executing payment requests via social media as shown and described herein.

FIG. 4 is a flow chart of another embodiment of a process for receiving and executing payment requests via social media as shown and described herein.

FIG. 5 is a processing flow diagram of another embodiment of a process for receiving and executing payment requests via social media as shown and described herein.

FIG. 6 is a flow chart of another embodiment of a process for receiving and executing payment requests via social media as shown and described herein.

FIG. 7 is a processing flow diagram of another embodiment of a process for receiving and executing payment requests via social media as shown and described herein.

FIG. 8 is a data flow diagram illustrating an embodiment of a social pay enrollment procedure in some embodiments of the social payment controller as shown and described herein.

FIG. 9 is a logic flow diagram illustrating aspects of an embodiment of social pay enrollment in some embodiments of the social payment controller as shown and described herein.

FIGS. 10A-C are data flow diagrams illustrating an embodiment of a social payment triggering procedure in some embodiments of the social payment controller as shown and described herein.

FIG. 11 is a user interface diagram illustrating an overview of example features of virtual wallet applications in some embodiments of the social payment controller.

FIG. 12 is a block diagram illustrating embodiments of a social payment controller.

FIG. 13 is a high level illustration of example elements of an embodiment of a system that includes a social payment controller.

FIG. 14 is a schematic illustration of elements of an embodiment of an example computing device.

FIG. 15 is a schematic illustration of elements of an embodiment of a server type computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

The embodiments of the methods and systems disclosed herein relate to a “social payment controller” that may transform message posts to social networks, via SocialPay components, in order to send payment information. The systems and methods related to the disclosed social payment controller override the routine and conventional sequence of events normally used in both social network environments and electronic payment systems. Consumers may benefit from the systems and methods described herein by gaining access to additional and more convenient mechanisms by which to make electronic transactions, thereby saving time and effort. Payment system providers and payment card issuers may also benefit from the increased convenience and accessibility for electronic transactions because the disclosed social payment controller may allow for more transactions as a result. Additionally, the systems and methods shown and described herein are necessarily rooted in computer technology. Specifically, making electronic payment transactions necessarily involve the use of computers and networks, and cannot be replicated in a non-computer context.

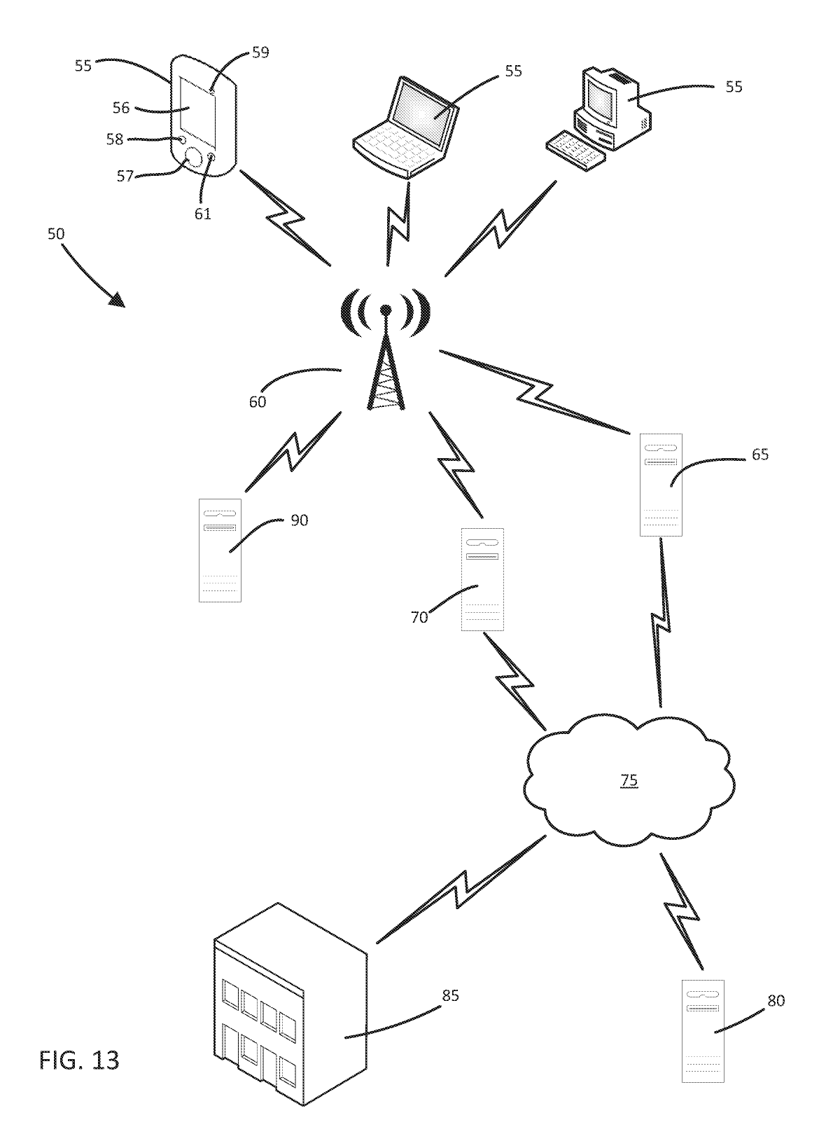

A high level illustration of some of the elements in a sample computing system 50 that may be physically configured to implement the social payment controller process and system is illustrated in FIG. 13. The system 50 may include any number of computing devices 55, such as smart phones or tablet computers, mobile computing devices, wearable mobile devices, desktop computers, laptop computers, or any other computing devices that allow users to interface with a digital communications network, such as digital communication network 60. Connection to the digital communication network 60 may be wired or wireless, and may be via the internet or via a cellular network or any other suitable connection service. Various other computer servers may also be connected to via the digital communication network 60, such as a social payment server 65, a merchant server 70, a payment server 85, a social network server 90, and a token server 80. The payment card server 85 may represent, for example, a credit card issuer, a bank, or another financial institution. Various of these servers or computer entities may also be connected through a secure payment network 75. The payment network 75 may be an electronic payment system used to accept, transmit, or process transactions made by users with payment cards for money, goods, or services, and to transfer information and funds among payment card issuers, merchants, payment card holders, payment processors, acquirers, etc. In the illustrated embodiment, at least the merchant server 70, the token server 80, and the payment server 85 may be connected via the payment network 75, but it is contemplated that other entities, such as the social payment server 65 or an acquirer may be connected as well.

In one embodiment, the computing device 55 may be a device that operates using a portable power source, such as a battery. The computing device 55 may also have a display 56 which may or may not be a touch sensitive display. More specifically, the display 56 may have a capacitance sensor, for example, that may be used to provide input data to the computing device 55. In other embodiments, an input pad 57 such as arrows, scroll wheels, keyboards, etc., may be used to provide inputs to the computing device 55. In addition, the computing device 55 may have a microphone 58 which may accept and store verbal data, a camera 59 to accept images and a speaker 61 to communicate sounds.

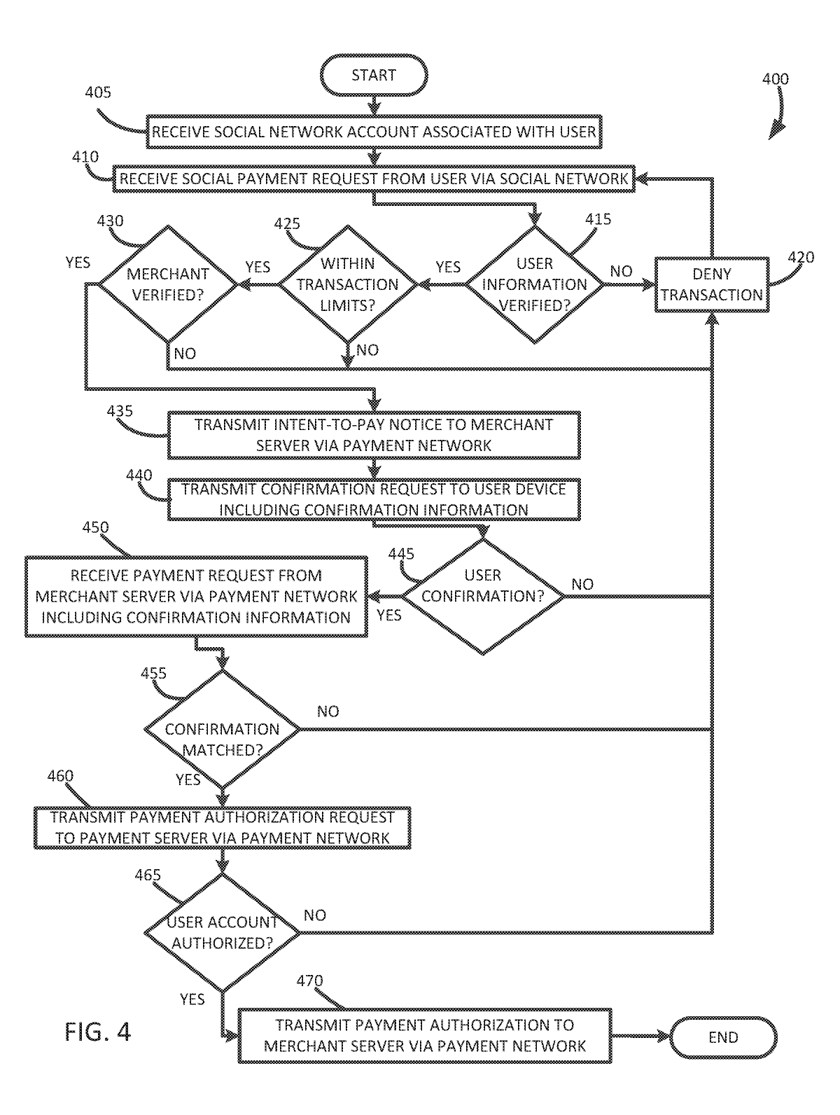

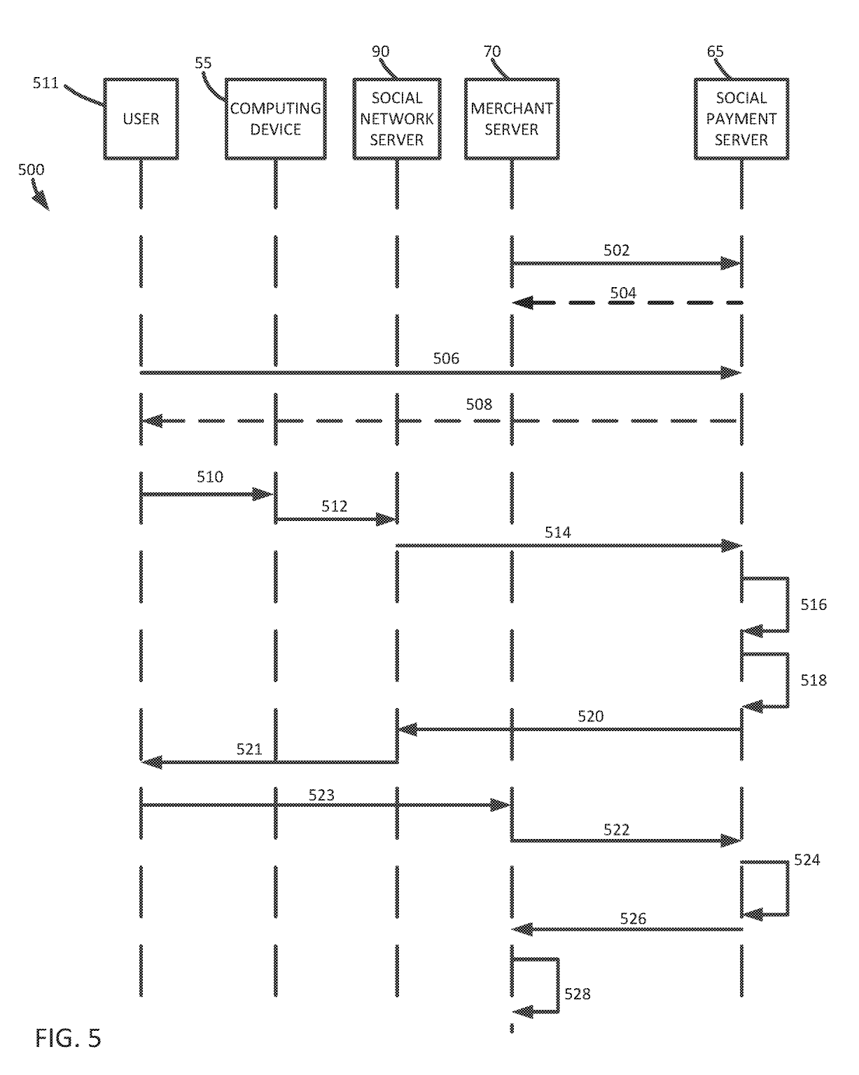

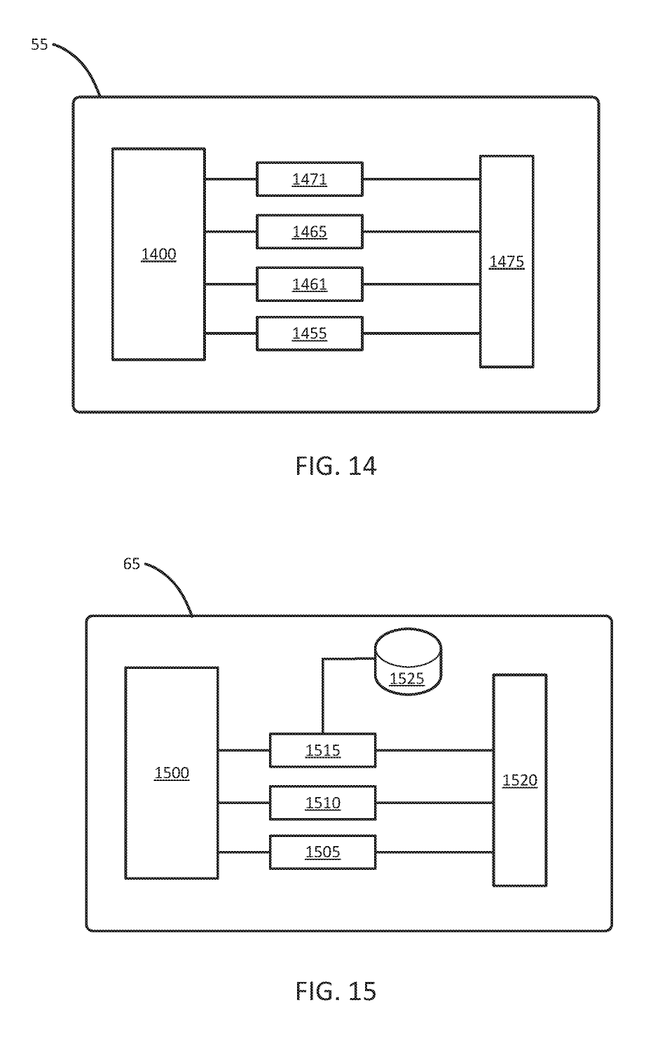

FIG. 14 is a simplified illustration of the physical elements that make up an embodiment of a computing device 55 and FIG. 5 is a simplified illustration of the physical elements that make up an embodiment of a server type computing device, such as the social payment server 65, but the merchant server 70, the social network server 90, and the token server 80 may reflect similar physical elements in some embodiments. Referring to FIG. 4, a sample computing device 55 is illustrated that is physically configured according to be part of the computing system 50 shown in FIG. 13. The portable computing device 55 may have a processor 1451 that is physically configured according to computer executable instructions. In some embodiments, the processor can be specially designed or configured to optimize communication between the server 65 and the computing device 55 relating to the e-commerce enabler application and rewards incentive system discussed herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera 59, a display 56, or other input/output devices. The portable computing device 55 also may control communicating with the networks, such as communication network 60 in FIG. 13, either through wireless or wired devices. Of course, this is just one embodiment of the portable computing device 55 and the number and types of portable computing devices 55 is limited only by the imagination.

The physical elements that make up an embodiment of a server, such as the social payment server 65, are further illustrated in FIG. 15. In some embodiments, the social payment server is specially configured to run the social payment controller as described herein. At a high level, the social payment server 65 may include a digital storage such as a magnetic disk, an optical disk, flash storage, non-volatile storage, etc. Structured data may be stored in the digital storage such as in a database. More specifically, the server 65 may have a processor 1500 that is physically configured according to computer executable instructions. In some embodiments, the processor 1500 can be specially designed or configured to optimize communication between a portable computing device, such as computing device 55, and the server 65 relating to the social payment controller as described herein. The server 65 may also have a sound and video module 1505 which assists in displaying video and sound and may turn off when not in use to conserve power and battery life. The server 65 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with the networks, such as communication network 60 and payment network 75, either through wireless or wired devices. In some embodiments, the social payment controller may be located on the computing device 55. However, in other embodiments, the social payment controller may be located on social payment server 65, or both the computing device 55 and the server 65. Of course, this is just one embodiment of the social payment server 65 and additional types of servers are contemplated herein.

In the embodiment illustrated in FIG. 13, the social payment server 65 may be connected to the merchant server 70 either through the digital communication network 60 or through other connections. In some embodiments, the merchant server 70 may be associated with any type of merchant offering goods or services for purchase with payment cards, whether those purchases are online or otherwise. For online purchases, the merchant server 70 or a group of servers may host a merchant website where the merchant's goods or services may be purchases by a consumer. In some embodiments, the social payment controller may collect payment information from the consumer, such as payment card credentials, that may be used for the immediate transactions as well as for future purchases with the same or other merchants. As such, the social payment controller may consolidate the entities to which a consumer shares its confidential payment information. Specifically, the consumer may share its payment card information with the social payment controller via software or other interface hosted by the social payment controller, and the social payment controller may provide the relevant payment information to a variety of merchants with whom the consumer would like to transact purchases. In some embodiments, the social payment controller may have particular merchants integrated to the social payment controller.

In some embodiments, a consumer may access the social payment server 65 via a computing device 55 such as a smartphone, and may set up an account with the social payment controller. The consumer may provide payment card or banking information for one or more payment cards provided by one or more card issuers. The social payment controller may store such payment card information associated with the consumer's account that can be retrieved at the consumers request to complete e-commerce transactions. Purchases using payment information stored with the social payment controller, however, may occur in any of a variety of ways. In some embodiments, the consumer may select a payment account or card stored through the social payment controller for use performing a given transaction.

The computing device 55 may be able to communicate with a computer server or a plurality servers, such as the social payment server 65, the merchant server 70, and the social network server 90. The computing device 55 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server or may be through a digital communication network 60 such as cellular service, through the Internet, through a private network, through Bluetooth, etc.

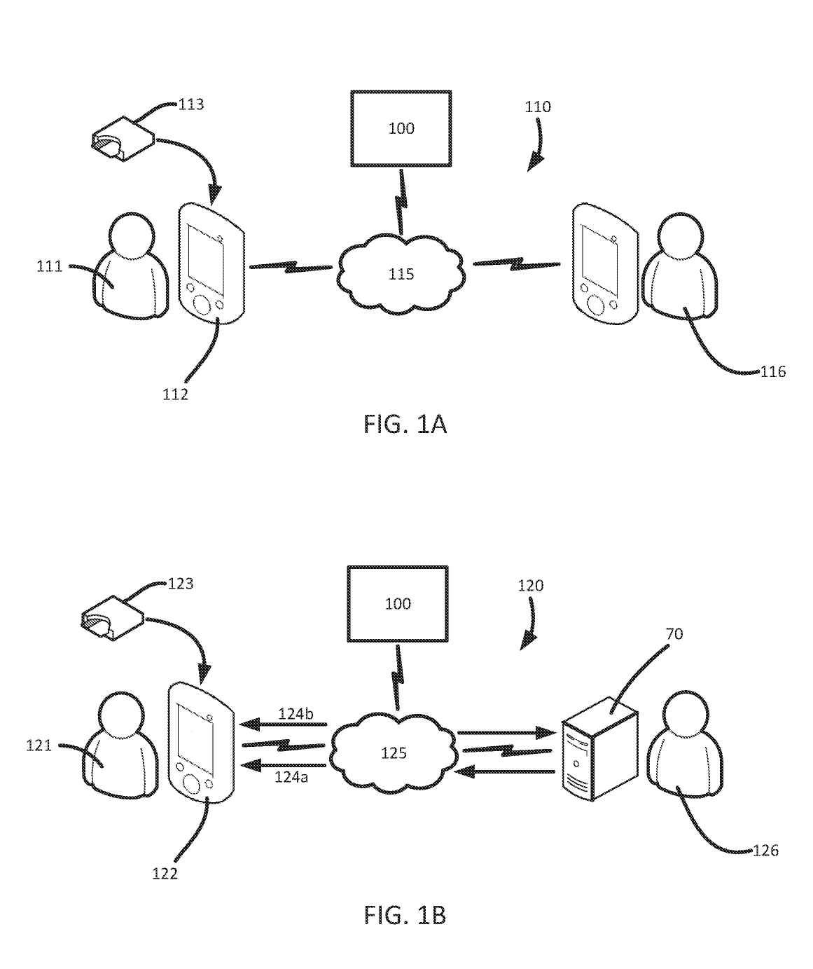

FIGS. 1A-B show simplified block diagrams illustrating example aspects of payment transactions via social networks in some embodiments of the social payment controller 100. In some embodiments, the social payment controller 100 may facilitate person-to-person transfers 110 of money via social networks. For example, a user, such as a first user 111, may wish to provide funds (dollars, rewards, points, miles, etc.) to another user, such as a second user 116. The first user 111 may utilize a virtual wallet 113 to provide a source of funds. The virtual wallet 113, for example, may be linked to any number of payment cards or bank accounts. In some embodiments, the first user 111 may utilize a computing device 112 (such as a smartphone, mobile device, laptop computer, desktop computer, and/or the like) to send a social post message via a social network or group of social networks 115. In some embodiments, the social network 115 may be hosted on the social network server 90, or a group of social network servers making up a cloud of servers. In some embodiments, the social post message may include information on an amount of funds to be transferred and an identity of another user to whom the funds should be transferred. The social payment controller 100 may intercept the message before it is sent to the social networking service, or it may obtain the message from the social networking service. Using the social post message, the social payment controller 100 may resolve the identities of a payer and payee in the transaction. The social payment controller 100 may identify accounts of the payer and payee to/from which funds need be credited or debited, and an amount of credit/debit to apply to each of the accounts. The social payment controller 100 may, on the basis of resolving this information, execute a transaction to transfer funds from the payer to the payee.

For example, the social payment controller 100 may allow a payer, such as the first user 111, to transfer funds to a payee (user ID jfdoe) and request an acknowledgement from SocialPay of receipt of funds by sending a tweet on Twitter™ such as “$25 @jfdoe #ackpls”. In another example, the social payment controller 100 may allow a potential payee, such as the second user 116 (user ID jfdoe) to request funds from the first user 111 (user ID johnq) by sending a tweet on Twitter™ such as “@johnq, you owe me 50000 Visa rewards points #id1234.” The social payment controller 100 may automatically provide an alert within a virtual wallet application of the first user with user ID johnq to provide the requested funds to the second user 116. The first user, johnq, may respond by sending a tweet in response, referencing the id (#id1234), such as “50000 vpts @jfdoe #id1234”; the social payment controller 100 may transfer the funds and recognize transaction request #id1234 as being fulfilled. In some embodiments, the social payment controller 100 may generate transaction/request ID numbers for the users to prevent coinciding transaction/request ID numbers for different transaction/requests.

In some embodiments, the social payment controller 100 may utilize one or more social networking services (e.g., Facebook®, Twitter™, MySpace™, etc.) 115. In some embodiments, the social payment controller 100 may allow users across different social networks 115 to transact with each other. For example, a second user 116 may make a request for payment on one social network to a first user 111 on another social network. As an example, the second user 116, via Twitter™, may tweet “@johnq@facebook.com, you owe me 500 vpts #ID7890”. The social payment controller may receive the tweet and provide an alert via another social networking service, such as Facebook®, to the first user 111 with ID johnq@facebook.com. In response, the first user 111 payer may social post to Facebook® a message “@jfdoe: here's your 500 vpts #ID7890”, and the social payment controller 100 may facilitate the payment transaction and provide a receipt/acknowledgment to the two users on their respective social networks 115 or virtual wallets 113.

In some embodiments, the social payment controller 100 may facilitate transfers of funds to more than one payee by a payer via a single social post message. In some embodiments, the social payment controller 100 may facilitate use of more than one source of funds of a payer to fund payment of funds to one or more payee via a single post message. For example, the social payment controller 100 may utilize default settings or customized rules, stored within a virtual wallet 113 of a payer, to determine which funding sources to utilize to fund a payment transaction to one or more payees via a social post message.

In some implementations, such as illustrated in FIG. 1B, the social payment controller may facilitate merchants to make offers of products and/or services to consumers via social networks 120. For example, a merchant 126 may sign up to participate in the social payment controller 100. In some embodiments, the merchant 126 may be associated with merchant server 70, which may host the merchant's website or other e-commerce platform through which a user 121 may initiate transactions. The social payment controller 100 may aggregate transactions of a user, such as user 121, and determine any products or services that may be relevant for offering to the user. The social payment controller 100 may determine whether any participating merchants are available to provide the products or services for the users. If so, the social payment controller 100 may provide social post messages via a social network 125 on behalf of the merchants, such as merchant 126 (or, alternatively, inform the merchants who may then send social post messages to the users), providing the offers 124a to the user 121. An example of an offer to the Twitter™ followers of a merchant 126 may be “@amazon offers the new Kindle™ at only $149.99—click here to buy.” In such an example, the offer posted on the social networking site may have a link embedded (e.g., “here”) that users can click to make the purchase (which may be automatically performed with one-click if they are currently logged into their virtual wallet accounts 123). Another example of a merchant offer may be “@amazon offers the new Kindle™ at only $149.99—reply with #offerID123456 to buy.” In such an example, the hash tag value serves as an identifier of the offer, which the users can reference when making their purchase via their social post messages (e.g., “buy from @amazon #offerID123456”). In some embodiments, merchants may provide two or more offers via a single social post message. In some embodiments, users may reference two or more offers in the same social post message.

In some implementations, users and/or merchants may utilize alternate messaging modes. For example, a user may be able to utilize electronic mail, SMS messages, phone calls, etc., to communicate with the social payment controller 100 and the social networks 125. For example, a merchant 126 may provide a social post message offer such as ““@amazon offers the new Kindle™ at only $149.99—text #offerID123456 to buy”. When a user 121 utilizes a computing device or mobile phone 122 to send a text message to redeem the offer, the social payment controller 100 may utilize a user profile of the user stored on the social networking service 125 to identify an identifying attribute of the user's mobile phone (e.g., a phone number), by which the social payment controller may correlate the text message to the particular user. Thus, the social payment controller 100 may be able to process a transaction with the merchant 126 on behalf of the user 121 using user information from the user's virtual wallet 123 when the user initiates a transaction using a text message. In some embodiments where a social network 125 is incapable of handling a particular mode of communication, the social payment controller 100 may serve as an intermediary translator to convert the message to a form that can be utilized by the social network. For example, if certain a social networking service is incapable of processing text messages sent with a mobile device over a cellular carrier, the social payment controller 100 may receive the text message and convert it to a form the social network may recognize.

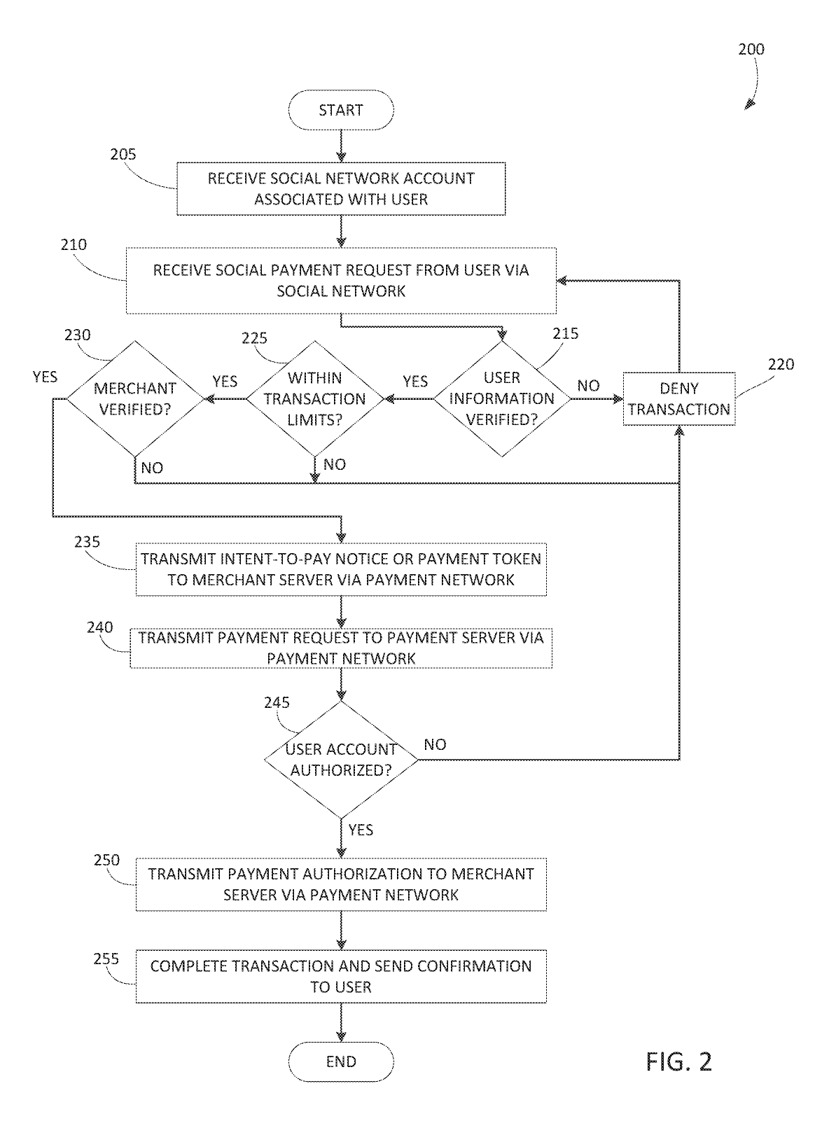

FIG. 2 illustrates an embodiment of a process 200 for receiving and executing payment requests via social media that originate from a user (i.e. a payer) by the social payment controller. In some embodiments, the social payment controller may be run from the social payment server 65 as shown in FIG. 13. In some embodiments, to help with processing, at block 205, a user of the social payment controller may implement add/register the user's social networking accounts with social media networks, such as Twitter™ or Facebook®, with the user's profile at the social payment controller, which may be stored on the social payment server 65. The user's profile at the social payment controller may also include payment account information, such as credit cards or banking information to use for transactions. In some embodiments, the user may select a default payment account to use for transactions through the social payment controller, or may select a particular account upon initiating a transaction. After registration, in some embodiments, the user may set a maximum number of transactions and or a maximum amount for transactions that can be processed using the system per transaction or for a chosen time period. For example, a user may indicate that the user would like to allow a maximum of five transactions per day, that no single transaction may exceed $100, and that no more than $1,000 of transactions may be initiated during the course of a single week. Of course, the user may choose any amount for these limits.

After registration, the user may act as a payer and use its social network accounts, like Twitter™ or Facebook®, to send payments to a merchant associated with a transaction. To make a purchase, the user/payer may initiate a transaction by sending a social payment request associated with the transaction to the social payment system via a social network that may be hosted on the social network server 90. The social payment request may include payer information, such as the user's Twitter™ ID or Facebook® ID, payee/merchant information associated with the merchant, and other transaction information, such as a payment amount. In some embodiments, the social payment request may also include a product identifier or transaction number, such as a model number, a stock keeping unit (SKU) number, etc. At block 210, the social payment controller may intercept and thereby receive the social payment request, either before or after the request reaches the social network server 90. In some embodiments, the social payment controller may be screening each message sent by the user to determine when a social payment request has been sent. Alternatively, the social payment controller may only receive social payment requests that are directed to the social payment controller specifically. A non-limiting example of a social payment request directed specifically to the social payment controller is the user sending the following tweet at the time of checkout: “@socialpaymentcontroller @bestbuy for txn:123456 amount: $73.99.” In such an embodiment, the social payment request may initiate a transaction via the social payment controller with merchant information for Best Buy in an amount of $73.99 associated with transaction number 123456. Of course, many suitable commands may be used, and the content of each command may vary between merchants and between social networks.

In response to the social payment request, at block 215, the social payment controller may verify the user information associated with the request. For example, in some embodiments, the social payment controller may query the user profile stored on the social payment server 65 that is associated with the social network identification information included in the social payment request. If the social payment controller cannot verify the user ID information with a user profile account for at the social payment controller, the transaction may be denied at block 220. If the user information is verified, in some embodiments, at block 225, the social payment controller may determine whether the requested transaction exceeds any transaction limitations selected by the user and stored in the user's account profile. For example, if the user has selected a maximum $50 per transaction via the social payment controller, the social payment controller will deny the transaction at block 220 if the transaction initiated exceeds $50. In some embodiments, at block 230, the social payment controller may then verify whether the merchant identified in the social payment request is registered with the social payment controller. In some embodiments, if the identified merchant is not registered or otherwise does not participate in the type of transaction requested, the transaction may be denied at block 220.

If the user information is verified, the requested transaction does not exceed transaction limits, and the merchant is verified, the social payment controller may transmit an intent-to-pay notice to the merchant server 70 via the payment network 75 at block 235. The intent-to-pay notice may include a unique ID for the transaction, including all information required to process and authorize payment. Alternatively or additionally, in some embodiments, the social payment controller, at block 235, may transmit a payment token to the merchant server 70 instead of the user's actual payment account information stored on the social payment server 65. In such embodiments, the payment token may be sent through the payment network 75 via the token server 80. The payment token may include data that is only identifiable by authorized parties, such as a payment card provide or bank with which the user has an account. The payment token may identify to the merchant details associated with the requested transaction.

At block 240, the merchant may transmit a payment request to the payment server 85 of the payment card issuer or bank associated with the user's payment account and coded into the payment token. The payment request may include the unique ID included in the intent-to-pay notice or the identification included within the payment token. The payment card issuer may decode the payment token and determine whether the user's account is properly funded and otherwise authorized to complete the transaction at block 245. In some embodiments, the merchant may instead transmit the payment request, including the identifying transaction information, to the social payment server 65 for processing by the social payment controller. In such embodiments, the social payment controller may transmit the payment request to the payment server 85 for authorization by the payment card issuer. If the payment card issuer determines that the user's account is not authorized to complete the transaction, the transaction may be denied at 220. If the user account is authorized, however, the payment server 85 may process the payment request and, at block 250, provide payment authorization (e.g., a token, card number, etc.) back to the merchant server 70 via the payment network 75 that the merchant can use to process the payment. In some embodiments, the payment card issuer may alternatively or additionally transmit the payment authorization to the social payment server 65 for the social payment controller to confirm and transmit the payment authorization to the merchant server 70. At block 255, the transaction may be completed and the social payment controller may send a confirmation message to the user indicating that the transaction was successful.

Among other things, the process 200 illustrated in FIG. 2 may address the issue of payments that are made via a social network and triggered for immediate payment to a merchant without giving the merchant a chance to accept/deny/delay the payment. The processing system shown and described in FIG. 2 avoids such immediate payments (completed without merchant consent) because after receiving a payment request from the social network, the payment network may send the merchant an intent-to-pay notice (instead of immediate payment), which allows the merchant to request a payment token if it chooses to do so. The merchant may then use the payment token to process the payment. In other embodiments, the intent-to-pay may instead be sent by the user.

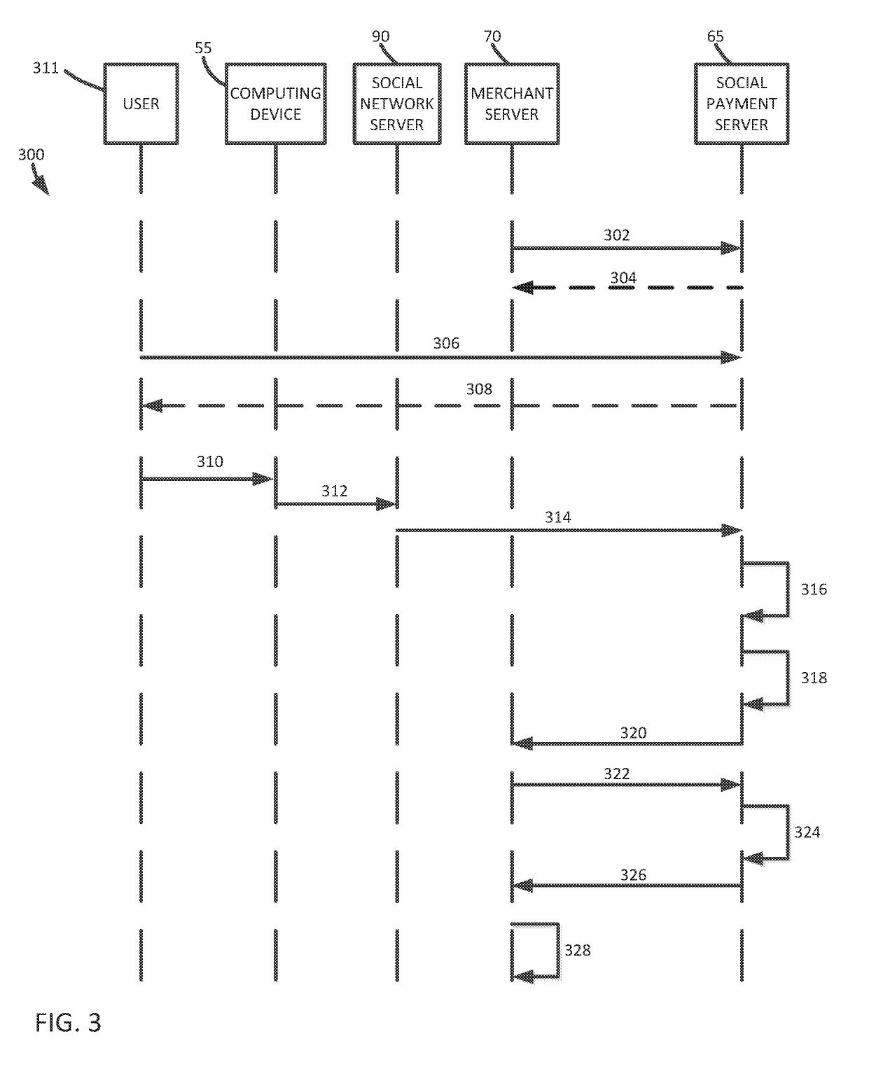

FIG. 3 illustrates a process diagram 300 for processing of payment requests for purchase transactions, money transfers, or other transactions, via the social payment controller. The scenario illustrates interactions among a user 311, a social networking enabled device such as the computing device 55 shown in FIG. 13, a social networking service hosted on a server such as the social network server 90, a payee/merchant using a server such as the merchant server 70, and a social payment controller run on a social payment server 65. In this embodiment, the user has a social media account with the social media network stored through the social network server 90, and the user has registered the social media account with the social payment controller stored on the social payment server 65.

Before a transaction takes place, the payee/merchant may register 302 with the social payment controller housed on the social payment server 65 so that the social payment controller may communicate with the payer/merchant and transmit information, data, and other messages 304 to the merchant server 70. Similarly, the user 311 may register 306 its social networking accounts with the social payment controller such that the user's payment accounts or other payment information may be correlated with the user's social networking accounts on the social payment server 65. Additionally, the social payment controller may also be able to transmit messages 308 such as payment confirmations, promotional offers, account information, etc. to the user through the user's social network account.

For processing a transaction, the user 311 may initiate a transaction by through input 310 into the user's computing device 55 that is social network enabled. The computing device 55 may transmit the social payment message 312 via a social network and the social network server 90 may receive the message. The social payment controller may detect and intercept the social payment message via the social network at 314 and the payment information included in the message. The social payment server 65 may receive the payment request initiated by the social payment message including payer information associated with the user and payee information associated with the payee/merchant. Thus, in some embodiments, a payment request may be initiated by the user, for example, via a social networking enabled computing device 55, and transmitted to the social payment server 65 via the social networking service.

At 316, the social payment controller may validate the user information by referencing the user account profile stored on the social payment server 65. Validation may include, for example, the social payment controller verifying that the payee/merchant is registered to receive payments initiated through the social media network. Subsequently, the social payment controller, at 318, may generate an intent-to-pay notice associated with the payment request and, at 320, transmit the intent-to-pay notice to the merchant server 70 including the payee/merchant information.

The payee/merchant may then, at 322, transmit to the social payment server 65 a payment information request for payment information. The payment information request may include information associated with the intent-to-pay notice. The social payment controller may then transmit, at 326 the payment information to the merchant server 70 in response to the payment information request. In some embodiments, for security purposes, at 324 the social payment controller may generate a payment token to send to the merchant server instead of the user's actual payment information, where the payment token may only be valid for processing the payment request and subsequently expires. At 328, the payment information may allow the payee/merchant to process a payment associated with the payment request.

FIG. 4 illustrates an embodiment of a process 400 for receiving and executing payment requests via social media that is similar to the process 200 in FIG. 2 but which may additionally include confirmation operations associated with the processing of the payment requests. In processing payment requests from a social network, the social payment controller may transmit confirmation information to the various parties involved in the transaction. In such embodiments, the confirmation information may be transmitted to the user via the social media network. In some embodiments, the user may transmit the confirmation information to the payee/merchant. The payee/merchant may then include the confirmation information when the payee/merchant generates a payment information request.

Thus, referring to FIG. 4, at block 405, a user of the social payment controller may implement add/register the user's social networking accounts with social media networks, such as Twitter™ or Facebook®, with the user's profile at the social payment controller. The user's profile at the social payment controller may also include payment account information and confirmation information specific to the user's account.

The user/payer may initiate a transaction by sending a social payment request associated with the transaction to the social payment system via a social network that may be hosted on the social network server 90. The social payment request may include payer information, such as the user's Twitter™ ID or Facebook® ID, payee/merchant information associated with the merchant, and other transaction information, such as a payment amount and confirmation information. At block 410, the social payment controller may intercept and thereby receive the social payment request, either before or after the request reaches the social network server 90.

In response to the social payment request, at block 415, the social payment controller may verify the user information associated with the request. For example, in some embodiments, the social payment controller may query the user profile stored on the social payment server 65 that is associated with the social network identification information included in the social payment request. If the social payment controller cannot verify the user ID information and confirmation information included with a user profile account for at the social payment controller, the transaction may be denied at block 420. If the user information and confirmation information is verified, in some embodiments, at block 425, the social payment controller may determine whether the requested transaction exceeds any transaction limitations selected by the user and stored in the user's account profile. In some embodiments, at block 430, the social payment controller may then verify whether the merchant identified in the social payment request is registered with the social payment controller.

If the user information is verified, the requested transaction does not exceed transaction limits, and the merchant is verified, the social payment controller may transmit an intent-to-pay notice to the merchant server 70 via the payment network 75 at block 435. The intent-to-pay notice may include a unique ID for the transaction, including all information required to recognize the transaction but not to process payment. Alternatively or additionally, in some embodiments, the social payment controller may transmit a payment token to the merchant server 70 instead of the user's actual payment account information stored on the social payment server 65, such as described with reference to FIG. 2 above.

At block 440, the social payment controller may transmit a confirmation request to the user device 55 either directly or via the social network service. The confirmation request may include confirmation information that may be later cross-checked against a payment request from the merchant server 70. At block 445, the user may choose to confirm or deny the transaction. If the transaction is denied, the merchant may not receive confirmation and the transaction may be cancelled at block 420. If the user confirms the transaction, then the merchant server 70 may receive payment confirmation information from the user device 55 either directly via the digital communication network 60 or via the social network service. At block 450, the social payment server 65 may receive a payment request from the merchant via the payment network 75 that includes the confirmation information provided by the user. At block 455, the social payment controller may check that the confirmation information received from the merchant server 70 matches the confirmation information sent to the user device 55 with the confirmation request. If not, the transaction may be denied.

If the confirmation information is matched at block 455, then the social payment controller may transmit a payment request to the payment server 85 of the payment card issuer or bank associated with the user's payment account and coded into the payment token at 460. The payment request may include the unique ID included in the intent-to-pay notice or the identification included within a payment token, and may also include the confirmation information. The payment card issuer may decode the payment token and determine whether the user's account is properly funded and otherwise authorized to complete the transaction at block 465. Authorization at block 465 may also include cross-checking the confirmation information to ensure it matches with information stored on the payment server 85 associated with the user's payment account. In some embodiments, the merchant may instead transmit the payment request directly to the payment server 85, including the identifying transaction information and confirmation information. In such embodiments, the payment server 85 may confirm that the confirmation information matches. If the payment card issuer determines that the user's account is not authorized to complete the transaction, the transaction may be denied at 420. If the user account is authorized, however, the payment server 85 may process the payment request and, at block 470, provide payment authorization (e.g., a token, card number, etc.) back to the merchant server 70 via the payment network 75 that the merchant can use to process the payment. In some embodiments, the payment card issuer may alternatively or additionally transmit the payment authorization to the social payment server 65 for the social payment controller to confirm and transmit the payment authorization to the merchant server 70. The transaction may be completed and the social payment controller may send a confirmation message to the user indicating that the transaction was successful.

FIG. 5 is a process diagram 500 of another embodiment for processing of payment requests for purchase transactions, money transfers, or other transactions, via the social payment controller. Similar to the process 300 in FIG. 3, the process diagram 500 illustrates interactions among a user 511, a social networking enabled device such as the computing device 55 shown in FIG. 13, a social networking service hosted on a server such as the social network server 90, a payee/merchant using a server such as the merchant server 70, and a social payment controller run on a social payment server 65. In this embodiment, the user may have a social media account with the social media network stored through the social network server 90, and the user may have registered the social media account with the social payment controller stored on the social payment server 65.

Before a transaction takes place, the payee/merchant may register 502 with the social payment controller housed on the social payment server 65 so that the social payment controller may communicate with the payer/merchant and transmit information, data, and other messages 504 to the merchant server 70. Similarly, the user 511 may register 506 its social networking accounts with the social payment controller such that the user's payment accounts or other payment information may be correlated with the user's social networking accounts on the social payment server 65. Additionally, the social payment controller may also be able to transmit messages 508 such as payment confirmations, promotional offers, account information, etc. to the user through the user's social network account.

For processing a transaction, the user 511 may initiate a transaction by through input 510 into the user's computing device 55 that is social network enabled. The computing device 55 may transmit the social payment message 512 via a social network and the social network server 90 may receive the message. The social payment controller may detect and intercept the social payment message via the social network at 514 and the payment information included in the message. The social payment server 65 may receive the payment request initiated by the social payment message including payer information associated with the user and payee information associated with the payee/merchant. Thus, in some embodiments, a payment request may be initiated by the user, for example, via a social networking enabled computing device 55, and transmitted to the social payment server 65 via the social networking service.

At 516, the social payment controller may validate the user information by referencing the user account profile stored on the social payment server 65. Validation may include, for example, the social payment controller verifying that the payee/merchant is registered to receive payments initiated through the social media network. Subsequently, the social payment controller, at 518, may generate an intent-to-pay notice associated with the payment request. At 520, the social payment controller may transmit confirmation information associated with the intent-to-pay notice to the user 511 via the social network server 90. At 521, the social network service may transmit corresponding confirmation message to the user 511 via the user's social network enabled computing device 55. In some embodiments, the confirmation information may include details of the transaction, such as payment amount, payee/merchant information, any items being purchases, etc., and may request that the user confirm that the user 511 would like to proceed with the transaction. At 523, the user 511 may make the appropriate inputs to the computing device 55 to respond to the confirmation information and transmit the confirmation to the merchant server 70. In some embodiments, the confirmation information is transmitted directly from the computing device 55 to the merchant server 70, and in other embodiments the confirmation information may be transmitted to the merchant server via the social network service.

At 522, once the merchant server 70 has received confirmation for the transaction, the merchant/payee may transmit to the social payment server 65 a payment information request for payment information. The payment information request may include information associated with the intent-to-pay notice and also may include the confirmation information to confirm with the social payment controller that the user has confirmed the transaction. The social payment controller may associate the payment information request with the intent-to-pay notice using the confirmation information included in the payment information request. The social payment controller may then transmit, at 526, the payment information to the merchant server 70 in response to the payment information request using information associated with the intent-to-pay notice. In some embodiments, for security purposes, at 524 the social payment controller may generate a payment token to send to the merchant server instead of the user's actual payment information, where the payment token may only be valid for processing the payment request and subsequently expires. At 528, the payment information may allow the payee/merchant to process a payment associated with the payment request.

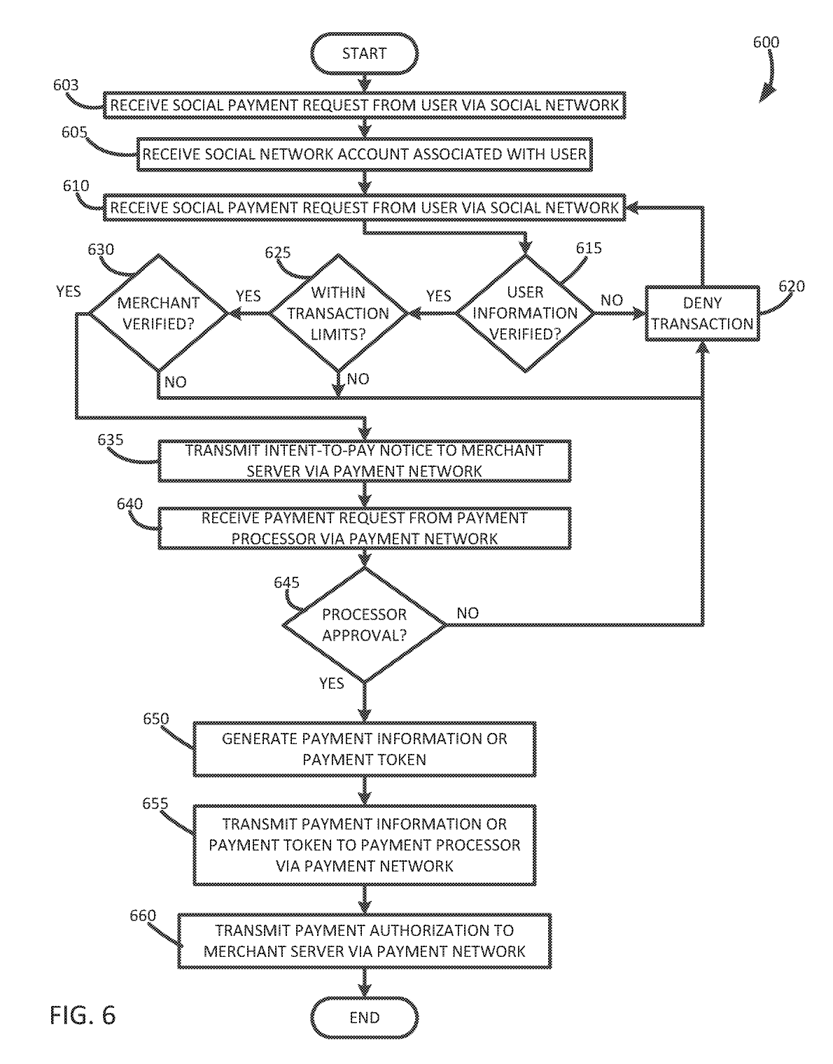

FIG. 6 depicts an embodiment of a process 600 for receiving and executing payment requests via social media that includes a payment processor 95 being used with the processing of payment requests from social media. The process 600 may be somewhat similar to the process 400 illustrated in FIG. 4, except that payments may be executed between the social payment server 65 and the payment processor 95. More specifically, in the process 600, a merchant can add its own payment processing accounts with the social payment controller. At the time of purchase, the user 611 can send a tweet or a post using the user's registered social networking account to the social payment controller requesting that the social payment controller send the payment information to the merchant server 70.

Referring to FIG. 6, at block 603, the social payment controller may receive payment processor information so as to register the payment processor 95 with the social payment controller and store the payment processor account information on the social payment server 65. In some embodiments, the payment processor 95 may be connected via the payment network 75. Based on instructions and permissions provided by the merchant and the payment processor, the social payment controller may also associate the payment processor with a specific merchant such that payments associated with transactions between users and the merchant may be directed through the payment processor. At block 605, a user of the social payment controller may implement add/register the user's social networking accounts with social media networks with the user's profile at the social payment controller. The user's profile at the social payment controller may also include payment account information and confirmation information specific to the user's account.

The user/payer may initiate a transaction by sending a social payment request associated with the transaction to the social payment system via a social network that may be hosted on the social network server 90. At block 610, the social payment controller may intercept and thereby receive the social payment request, either before or after the request reaches the social network server 90. In response to the social payment request, at block 615, the social payment controller may verify the user information associated with the request. If the social payment controller cannot verify the user ID information and confirmation information included with a user profile account for at the social payment controller, the transaction may be denied at block 620. If verified, in some embodiments, at block 625, the social payment controller may determine whether the requested transaction exceeds any transaction limitations selected by the user and stored in the user's account profile. In some embodiments, at block 630, the social payment controller may then verify whether the merchant identified in the social payment request is registered with the social payment controller.

If the user information is verified, the requested transaction does not exceed transaction limits, and the merchant is verified, the social payment controller may transmit an intent-to-pay notice to the merchant server 70 via the payment network 75 at block 635. The intent-to-pay notice may include a unique ID for the transaction, including all information required to recognize the transaction. The merchant server 70 may then forward the payment intent to the payment processor 95 and, at block 640, the social payment controller may receive a payment request from the payment processor 95 via the payment network 75. The payment request may include the unique ID or other confirmation information associated with the intent-to-pay to confirm authenticity of the request. At block 645, the social payment controller may confirm the association and approval of the payment processor 95 with respect the specific merchant involved in the transaction. If the social payment controller does not find that the merchant has approved the payment processor, the transaction may be cancelled at block 620. Otherwise, at block 650, the social payment controller may generate payment information associated with the user. In some embodiments, generating payment information may include requesting authorization from the payment card issue or bank account associated with the user's account, and may include generating a payment token to pass onto the payment processor instead of the user's actual payment information. At block 655, the social payment controller may transmit the payment information or payment token to the payment processor 95 via the payment network 75, allowing the payment processor and the merchant to finalize the transaction.

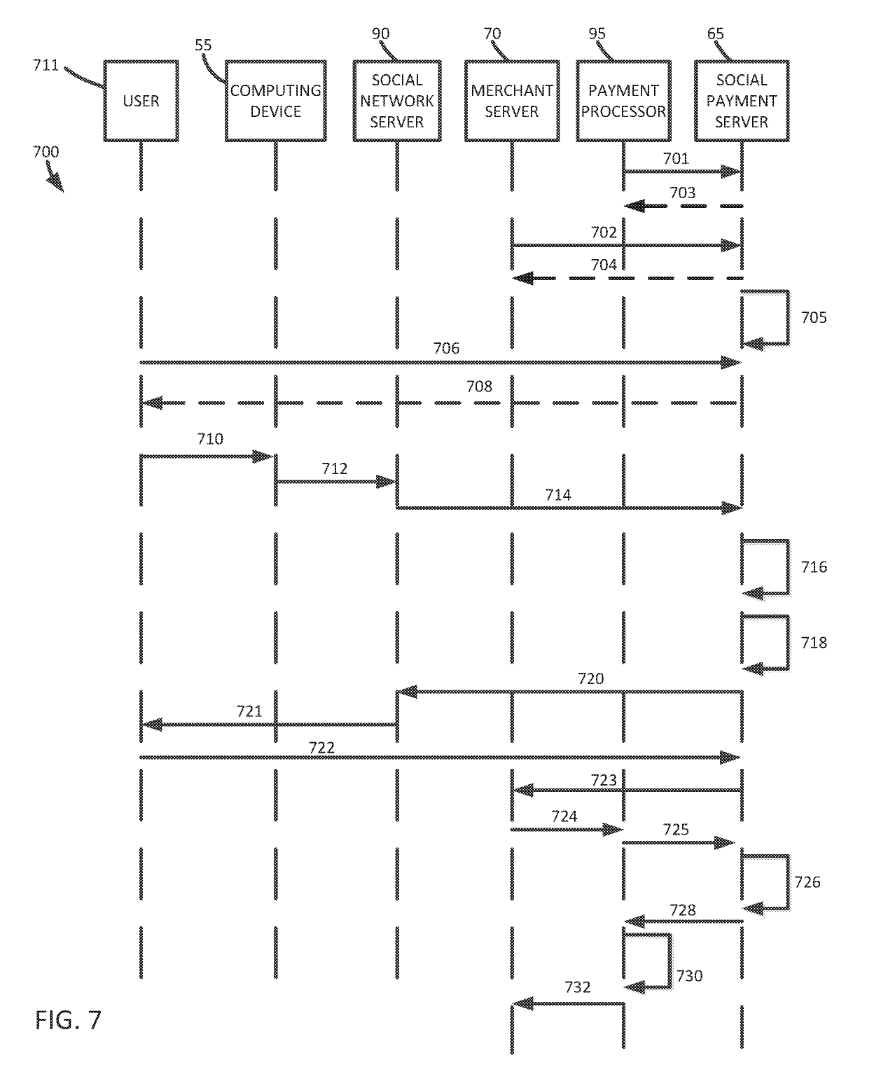

FIG. 7 is a process diagram 700 of another embodiment for processing of payment requests for purchase transactions, money transfers, or other transactions, via the social payment controller. The process 700 may additionally include a payment processor 95 being used with the processing of payment requests from social media. The embodiment in FIG. 7 illustrates interactions among a user, a social networking enabled computing device 55, a social networking server 90 hosting a social network service, a merchant server 70 used by a merchant, the social payment controller run on the social payment server 65, as well as a payment processor 95 (or payment recipient partner).

In this scenario, a payment processor/partner 95, at 701, may register with the social payment controller housed on the social payment server 65 so that the social payment controller may communicate with the payment processor and transmit information, data, and other messages 703 to the payment processor. At 702, the payee/merchant may register with the social payment controller housed on the social payment server 65 so that the social payment controller may communicate with the payer/merchant and transmit information, data, and other messages 704 to the merchant server 70. At 705, the social payment controller may establish a relationship between a merchant server 70 and the payment processor 95.

Similarly, the user 711 may register 706 its social networking accounts with the social payment controller such that the user's payment accounts or other payment information may be correlated with the user's social networking accounts on the social payment server 65. Additionally, the social payment controller may also be able to transmit messages 708 such as payment confirmations, promotional offers, account information, etc. to the user through the user's social network account.

For processing a transaction, the user 711 may initiate a transaction by through input 710 into the user's computing device 55 that is social network enabled. The computing device 55 may transmit the social payment message 712 via a social network and the social network server 90 may receive the message. The social payment controller may detect and intercept the social payment message via the social network at 714 and the payment information included in the message. The social payment server 65 may receive the payment request initiated by the social payment message including payer information associated with the user and payee information associated with the payee/merchant. Thus, in some embodiments, a payment request may be initiated by the user, for example, via a social networking enabled computing device 55, and transmitted to the social payment server 65 via the social networking service.

At 716, the social payment controller may validate the user information by referencing the user account profile stored on the social payment server 65. Validation may include, for example, the social payment controller verifying that the payee/merchant is registered to receive payments initiated through the social media network. Subsequently, the social payment controller, at 718, may generate an intent-to-pay notice associated with the payment request. At 720, the social payment controller may transmit confirmation information associated with the intent-to-pay notice to the user 711 via the social network server 90. At 721, the social network service may transmit corresponding confirmation message to the user 711 via the user's social network enabled computing device 55. In some embodiments, the confirmation information may include details of the transaction, such as payment amount, payee/merchant information, any items being purchases, etc., and may request that the user confirm that the user 711 would like to proceed with the transaction. At 722, the user 711 may make the appropriate inputs to the computing device 55 to respond to the confirmation information and transmit the confirmation to the social payment server 65 either directly or via the social network service. In some embodiments, the confirmation information is transmitted directly from the computing device 55 to the merchant server 70.

At 723, once the social payment controller has received confirmation for the transaction, the social payment controller may transmit an intent-to-pay notice to the merchant server 70. The intent-to-pay notice may include the confirmation information to confirm with the merchant that the user 711 has confirmed the transaction. At 724, the merchant may forward the intent-to-pay notice to the payment processor, who may then, at 725, transmit a payment request to the social payment server 65. The social payment controller may then transmit, at 728, the payment information to the payment processor 90 in response to the payment request using information associated with the intent-to-pay notice. In some embodiments, for security purposes, at 726 the social payment controller may generate a payment token to send to the payment processor instead of the user's actual payment information, where the payment token may only be valid for processing the payment request and subsequently expires. At 730, the payment information may allow the payment processor to process a payment associated with the payment request. The payment processor 90 may then send payment confirmation to the merchant server 70 at 732.

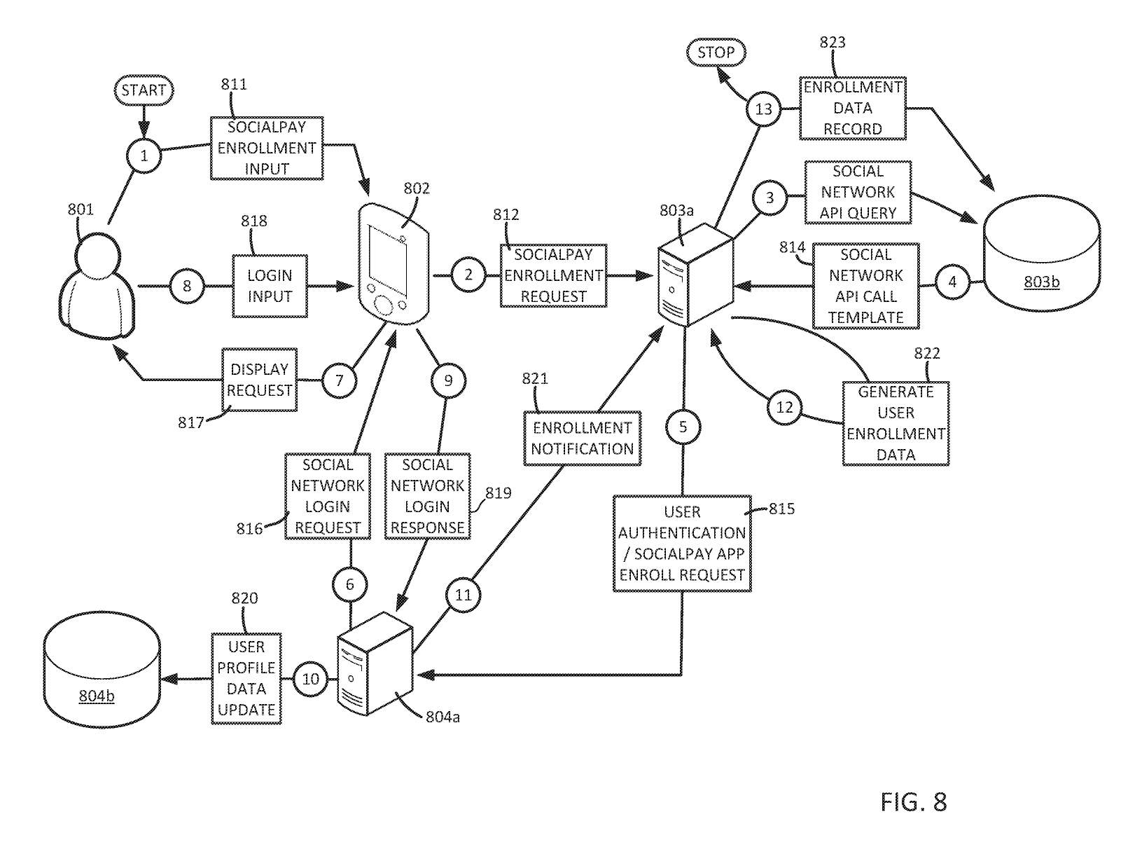

FIG. 8 shows a data flow diagram illustrating an example social pay enrollment procedure in some embodiments of the social payment controller. In some embodiments, a user, e.g., 801, may desire to enroll in a SocialPay program associated with the social payment controller. The user may communicate with a SocialPay server, e.g., 803a, via a client such as, but not limited to: a personal computer, mobile device, television, point-of-sale terminal, kiosk, ATM, and/or the like (e.g., 802). For example, the user may provide user input, e.g., social pay enrollment input 811, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like.

In some implementations, using the user's input, the client may generate a social pay enrollment request, e.g., 812, and provide the enrollment request to the social payment controller server 803a. For example, the client may provide a (Secure) Hypertext Transfer Protocol (“HTTP(S)”) POST message including data formatted according to the eXtensible Markup Language (“XML”). Below is an example HTTP(S) POST message including an XML-formatted enrollment request for the social payment server:

```
POST /enroll.php HTTP/1.1
Host: www.socialpay.com
Content-Type: Application/XML
Content-Length: 484
<?XML version = “1.0” encoding = “UTF-8”?>
<enrollment_request>
  <request_ID>4NFU4RG94</request_ID>
  <timestamp>2011-02-22 15:22:43</timestamp>
  <user_ID>john.q.public@facebook.com</user_ID>
  <wallet_account_ID>7865493028712345</wallet_account_ID>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
    </client_details>
  </enrollment_request>
```

In some embodiments, the social payment server may obtain the enrollment request from the client, and extract the user's payment detail (e.g., XML data) from the enrollment request. In some implementations, the social payment server may query, e.g., 813, a social pay database, e.g., 803b, to obtain a social network request template, e.g., 814, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 814-815, is provided below:

```
<?PHP
header(′Content-Type: text/plain′);
mysql_connect(“254.93.179.112”,$DBserver,$password);
  // access database server
mysql_select_db(“SOCIALPAY.SQL”); // select database table to search
//create query
$query = “SELECT template FROM EnrollTable WHERE
  network LIKE ′%′ $socialnet”;
$result = mysql_query($query); // perform the search query
mysql_close(“SOCIALAUTH.SQL”); // close database access
?>
```

In some implementations, the social payment server may redirect the client to a social network server, e.g., 804a, by providing a HTTP(S) REDIRECT 300 message, similar to the example below:

```
HTTP/1.1 300 Multiple Choices
Location:
  https://www.facebook.com/dialog/oauth?
  client_id=snpa_app_ID&redirect_uri=
  www.paynetwork.com/enroll.php
<html>
  <head><title>300 Multiple Choices</title></head>
  <body><h1>Multiple Choices</h1></body>
</html>
```

In some implementations, the social payment server may provide information extracted from the social pay enrollment request to the social network server as part of a user authentication/social pay app enroll request, e.g., 815. For example, the social payment server may provide a HTTP(S) POST message to the social network server, similar to the example below:

```
POST /authenticate_enroll.php HTTP/1.1
Host: www.socialnet.com
Content-Type: Application/XML
Content-Length: 484
<?XML version = “1.0” encoding = “UTF-8”?>
<enrollment_request>
  <request_ID>4NFU4RG94</request_ID>
  <timestamp>2011-02-22 15:22:43</timestamp>
  <user_ID>john.q.public@facebook.com</user_ID>
  <wallet_account_ID>7865493028712345</wallet_account_ID>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
</enrollment_request>
```

In some implementations, the social network server may provide a social network login request, e.g., 816, to the client. For example, the social network server may provide a HTML input form to the client. The client may display, e.g., 817, the login form for the user. In some implementations, the user may provide login input into the client, e.g., 818, and the client may generate a social network login response, e.g., 819, for the social network server. In some implementations, the social network server may authenticate the login credentials of the user, and upon doing so, update the profile of the user to indicate the user's enrollment in the social pay system. For example, in a social networking service such as Facebook®, the social network server may provide permission to a social pay third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 820, and provide an enrollment notification, e.g., 821, to the social payment server 803a. For example, the social network server 804a may provide a HTTP(S) POST message similar to the example below:

```
POST /enrollnotification.php HTTP/1.1
Host: www.socialpay.com
Content-Type: Application/XML
Content-Length: 1306
<?XML version = “1.0” encoding = “UTF-8”?>
<enroll_notification>
  <request_ID>4NFU4RG94</request_ID>
  <timestamp>2011-02-22 15:22:43</timestamp>
  <result>enrolled</result>
</enroll_notification>
```

Upon receiving notification of enrollment from the social network server 804a, the social payment server 803a may generate, e.g., 822, a user enrollment data record, and store the enrollment data record in a social pay database, e.g., 823, to complete enrollment. In some implementations, the enrollment data record may include the information from the enrollment notification 821.

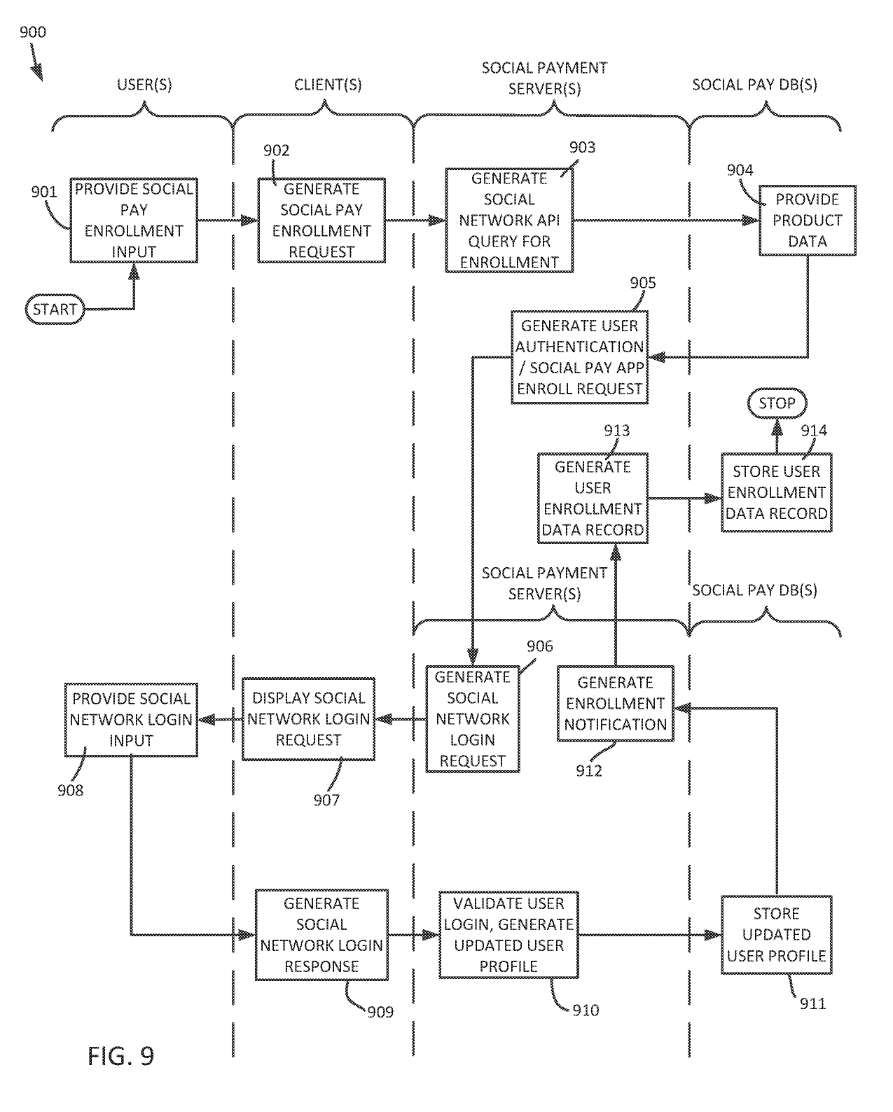

FIG. 9 shows a logic flow diagram illustrating example aspects of social pay enrollment in some embodiments of the social payment controller, e.g., a Social Pay Enrollment (“SPE”) component 900. In some embodiments, a user may desire to enroll in SocialPay. The user may provide user input, e.g., social pay enrollment input 901, into the client indicating the user's desire to enroll in social network authenticated purchase payment. In some implementations, using the user's input, the client may generate a social pay enrollment request, e.g., 902, and provide the enrollment request to the social payment server. In some embodiments, the social payment server may obtain the enrollment request from the client, and extract the user's payment detail (e.g., XML data) from the enrollment request.

In some implementations, the social payment server may query, e.g., 903, a social pay database, e.g., 904, to obtain a social network request template to process the enrollment request. The social network request template may include instructions, data, login URL, login API call template and/or the like for facilitating social network authentication. In some implementations, the social payment server may redirect the client to a social network server. In some implementations, the social payment server may provide information extracted from the social pay enrollment request to the social network server as part of a user authentication/social pay app enroll request, e.g., 905. In some implementations, the social network server may provide a social network login request, e.g., 906, to the client. For example, the social network server may provide a HTML input form to the client. The client may display, e.g., 307, the login form for the user. In some implementations, the user may provide login input into the client, e.g., 308, and the client may generate a social network login response, e.g., 309, for the social network server. In some implementations, the social network server may authenticate the login credentials of the user, and upon doing so, update the profile of the user to indicate the user's enrollment in the social pay system. For example, in a social networking service such as Facebook®, the social network server may provide permission to a social pay third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 910-911, and provide an enrollment notification, e.g., 912 to the social payment server. Upon receiving notification of enrollment from the social network server, the social payment server may generate, e.g., 913, a user enrollment data record, and store the enrollment data record in a social pay database, e.g., 914, to complete enrollment. In some implementations, the enrollment data record may include the information from the enrollment notification.

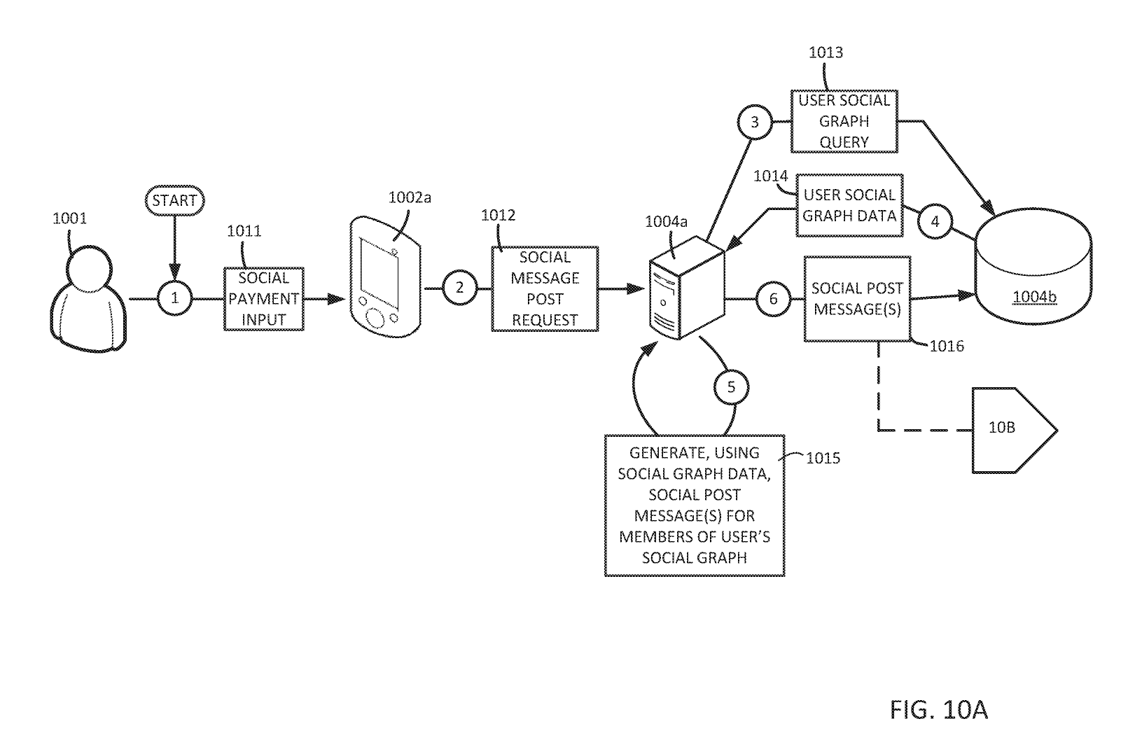

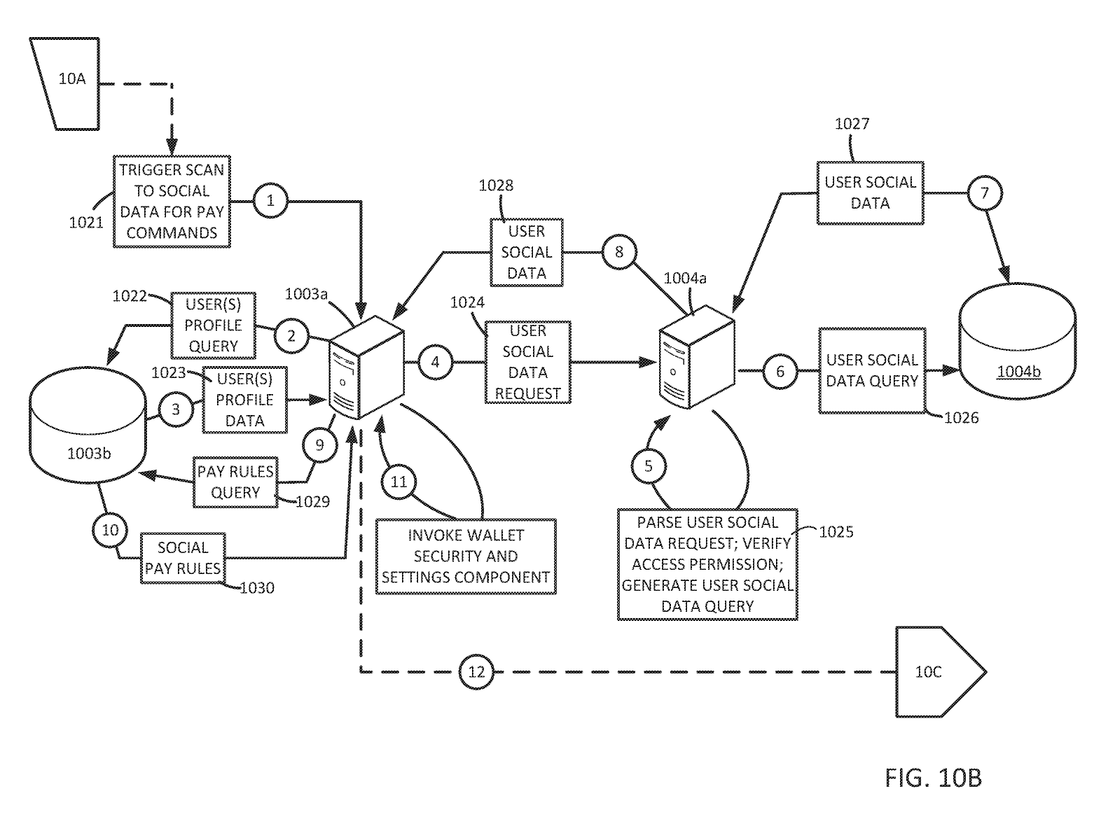

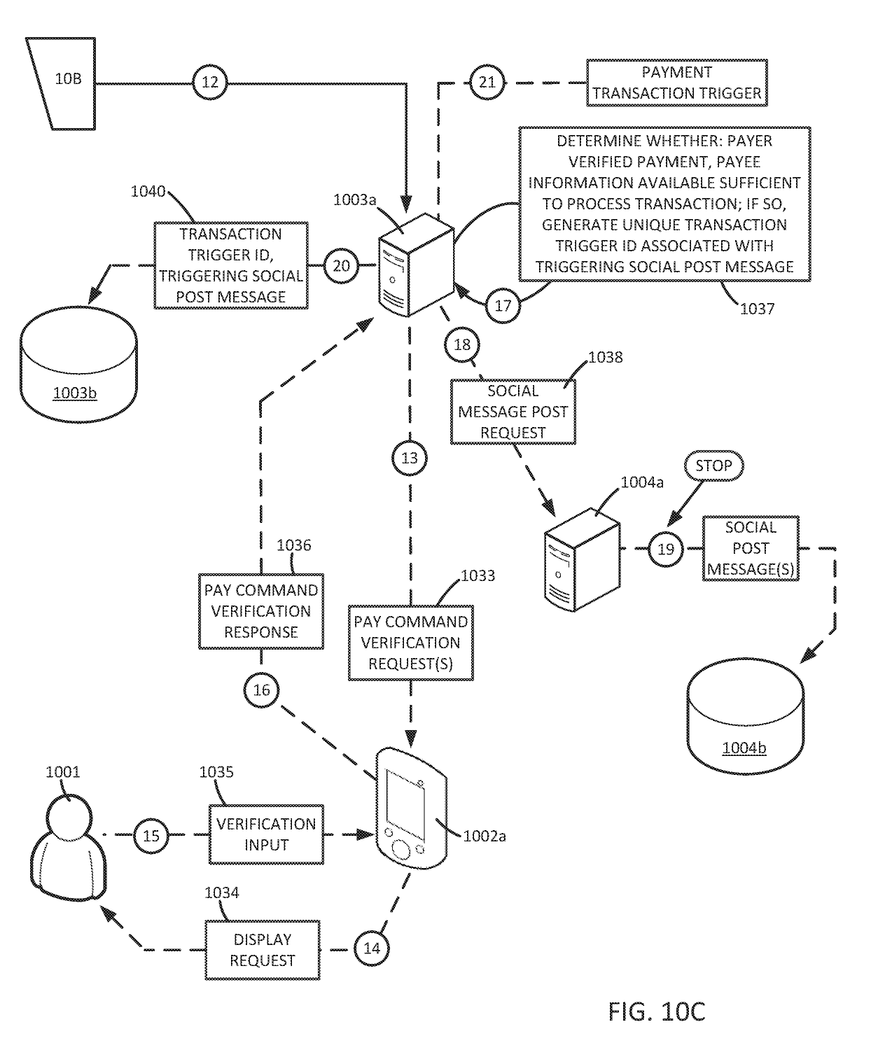

FIGS. 10A-C show data flow diagrams illustrating an example social payment triggering procedure in some embodiments of the social payment controller. With reference to FIG. 10A, in some embodiments, a user, e.g., user1 1001, may desire to provide or request funds from another (e.g., a user, a participating merchant, etc.). The user may communicate with a social network server, e.g., 1003a, via a client (client1 1002a) such as, but not limited to: a personal computer, mobile device, television, point-of-sale terminal, kiosk, ATM, and/or the like. For example, the user may provide social payment input 1011, into the client indicating the user's desire to provide or request funds from another. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In response, the client may provide a social message post request 1012 to the social network server. In some implementations, a virtual wallet application executing on the client may provide the user with an easy-to-use interface to generate and send the social message post request. In alternate implementations, the user may utilize other applications to provide the social message post request. For example, the client may provide a social message post request to the social network server as a HTTP(S) POST message including XML-formatted data. An example listing of a social message post request 412, substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
  <request_ID>value</request_ID>
  <timestamp>2011-02-02 03:04:05</timestamp>
  <sender_id>jfdoe@facebook.com</sender_id>
  <receiver_id>johnqp@facebook.com</receiver_id>
  <message>$25 @johnqp #thanksforagreattimelastnite</message>
</message_post_request>
```

The user may have signed up for numerous wallets. The message 1012 may be sent be sent from the user 1002a to a second user via the social network 1004a. In one example, user1 1001 may send $25 to johnq with a message “#thanksforagreattime” 1012b. SocialPay may later append various messages and/or send additional various messages that will appear to the target user to have been sent by user1 1001. As an example, here the social payment controller determined that user2 does not have a wallet into which they may redeem payment. As such, Social Pay, upon parsing and determination, may append a message to allow the receiving user to sign up for a wallet and thus obtain the payment from user1; in this example, social pay may append “signup at visa.com/wallet to redeem this payment.” It should be noted that various wallets may be employed and/or offered; for example, a social network may itself offer a wallet and as such another message of “signup at twitter.com/wallet to redeem this payment” may be appended. In another embodiment, social pay itself may host an e-wallet and as such the following message may be appended “signup at socialpay.com/wallet to redeem this payment.” In one example, the social payment controller server may use login credentials provided by a user to automatically simultaneously and permanently be logged in reading every social message/post entered by the user from other client programs and in addition received messages that are sent to the user by other users. As such, SocialPay may parse all transactions sent by the user and/or received messages that were directed to the user and determine which messages are directed to make person-to-person payments. In another embodiment, this type of interception parsing may be employed at the social network servers instead of at the social payment controller servers. In yet another embodiment, both the social payment controller server and the social network server may do this type of interception parsing, the details of which are described further below. It should be noted that, when this type of interception parsing is ongoing (which may be all the time unless a user specifically requests the cessation of such interception parsing), when the social payment controller server and/or other servers intercept messages and parse them and determine, e.g., they are triggers for payments, those servers may go on to process the parsed message triggering payment and other activities. For example, if the target user does not have an e-wallet account, upon look up and determination by the server, then the server may send a message in addition to the social message POST request 1012, where the additional message will provide details for where the target user may sign up and create an e-wallet account and redeem payment provided to them by another user/system. If SocialPay, instead, determines that the target user is already enrolled in an e-wallet, it may initiate and then facilitate the transfer of payment from the first user to the target user's account without further messaging or interaction (e.g., it may also require the target user to accept such payments, in which case it can send a second message to the target user asking them to reply to social pay saying yes to effectuate payment before such funds are delivered to the target user's e-wallet account).

In another embodiment, a Social Pay post message may be for an item. In such a sense, it may become a social gift message. For example, the message may be substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
      <message_link_label>iPad</message_link_label >
    <message_link_label_address>http:store.apple.com/
  ?itemquery?ipad_32GB_WiFi_white</message_link_label_address>
      <request_ID>value</request_ID>
      <store_login>jfdoe@mac.com</store_login>
      <store_pass>abc123</store_pass>
      <store_wallet_account>Apple Store
  ID123</store_wallet_account>
  <timestamp>2011-02-02 03:04:05</timestamp>
  <sender_id>jfdoe@facebook.com</sender_id>
  <receiver_id>johnqp@facebook.com</receiver_id>
  <message>iPad @johnqp #christmasgift</message>
</message_post_request>
```

In such an example, the user may post a link to an item (e.g., drag and drop a link for a product into their social messaging application which will translate and/or include both the link label (e.g., iPad) and the address for the item (e.g., http:store.apple.com/?itemquery?ipad_32 GB_WiFi_white) identifying the product skew at the merchant. Social Pay may then see if the user's wallet has an account with that merchant and provide login credentials to affect a purchase through the merchant and identify shipping addresses from the target user. In another embodiment, the gifting user may be prompted for login information, which may then be passed along to Social Pay to affect the purchase.

In some embodiments, the social network server 1004a may query its social network database for a social graph of the user, e.g., 1013. For example, the social network server may issue PHP/SQL commands to query a database table for social graph data associated with the user. An example user social graph query 1013, substantially in the form of PHP/SQL commands, is provided below:

```
<?PHP
header(′Content-Type: text/plain′);
mysql_connect(“254.93.179.112”,$DBserver,$password);
  // access database server
mysql_select_db(“SocialPay_DB.SQL”); // select database table to search
//create query
$query = “SELECT friend_name friend_type friend_
weight message_params_list
  messaging_restrictions FROM SocialGraphTable WHERE
  user LIKE ′%′
  $user_id”;
$result = mysql_query($query); // perform the search query
mysql_close(“SocialPay_DB.SQL”); // close database access
?>
```

In some embodiments, the social network database may provide the requested social graph data in response, e.g., 1014. Using the social graph data, the social network server may generate message(s) as appropriate for the user and/or members of the user's social graph, e.g., 1015, and store the messages 1016 for the user and/or social graph members.

With reference to FIG. 10B, in some embodiments, such posting of social messages may trigger SocialPay actions. For example, a social payment server 1003a may be triggered to scan the social data for pay commands. In embodiments where every social post message originates from the virtual wallet application of a user, the social payment controller may optionally obtain the pay commands from the virtual wallet applications, and skip scanning the social networks for pay commands associated with the user. In embodiments where a user is allowed to issue pay commands from any device (even those not linked to the user's virtual wallet), the social payment controller may periodically, or even continuously scan the social networks for pay commands, e.g., 1021. In embodiments where the social payment controller scans the social networks, the social payment server may query a social pay database for a profile of the user. For example, the social payment server may request a user ID and password for the social networks that the user provided to the social payment server during the enrollment phase. For example, the social payment controller server may issue PHP/SQL commands to query a database table for user profile data. An example user profile data query 1022, substantially in the form of PHP/SQL commands, is provided below:

```
<?PHP
header(′Content-Type: text/plain′);
mysql_connect(“254.93.179.112”,$DBserver,$password);
  // access database server
mysql_select_db(“SocialPay_DB.SQL”); // select database table to search
//create query
$query = “SELECT network_id network_name network_
api user_login user_pass
  FROM UsersTable WHERE userid LIKE ′%′ $user_id”;
$result = mysql_query($query); // perform the search query
mysql_close(“SocialPay_DB.SQL”); // close database access
?>
```

In response, the social pay database 1003b may provide the requested information, e.g., 1023. In some embodiments, the social payment server 1003a may provide a user social data request 1024 to the social network server 1004a. An example listing of commands to issue a user social data request 1024, substantially in the form of PHP commands, is provided below:

```
<?PHP
header(′Content-Type: text/plain′);
// Obtain user ID(s) of friends of the logged-in user
$friends =
  json_decode(file_get_contents(′https://graph.facebook.com/
  me/friends?access
  token=′$cookie[′oauth_access_token′]), true);
$friend_ids = array_keys($friends);
// Obtain message feed associated with the profile of the logged-in user
$feed =
  json_decode(file_get_contents(′https:llgraph.facebook.com/
  me/feed?access_token=′$cookie[′oauth_access_token′]), true);
// Obtain messages by the user's friends
$result = mysql_query(′SELECT * FROM content WHERE uid IN (′
  .implode($friend_ids, ′,′) . ′)′);
$friend_content = array( );
while ($row = mysql_fetch_assoc($result))
$friend_content [ ] $row;
?>
```

The user may have signed up for numerous wallets. The message 1024 may be sent from the user 1002a to a second user via the social network 1004a. In one example, user1 1001 may send $25 to johnq with a message “#thanksforagreattime” 1012b. SocialPay may later append various messages and/or send additional various messages, which will appear to the target user to have been sent by user1 1001. As an example, the social payment controller may determine that user2 does not have a wallet into which they may redeem payment. As such, SocialPay, upon parsing and determination, may append a message to allow the receiving user to sign up for a wallet and thus obtain the payment from user1; in this example, SocialPay may append “signup at visa.com/wallet to redeem this payment.” SocialPay may parse 1025 all transactions send by the user and/or received messages that were directed to the user and determine which messages are directed to make person to person/entity payments. In another embodiment, this type of interception parsing may be employed at the social network servers instead of at the social payment controller servers. In yet another embodiment, both the social payment controller server and the social network server may do this type of interception parsing, the details of which are described further below.

In some embodiments, the social network server may query, e.g., 1026, it social network database 1004b for social data results falling within the scope of the request. In response to the query, the database 1004b may provide social data, e.g., 1027. The social network server 1004a may return the social data obtained from the databases, e.g., 1028, to the social payment server 1003a. An example listing of user social data 1028, substantially in the form of JavaScript Object Notation (JSON)-formatted data, is provided below:

| [“data“: | ] | |
|---|---|---|
| | { | “name”: “Tabatha Orloff”, |
| | | “id”: “483722“}, |
| | { | “name”: “Darren Kinnaman”, |
| | | “id”: “86S743“}, |
| | { | “name”:“Sharron Jutras”, |
| | | “id”: “O91274”} |

]}

In some embodiments, the social payment server 1003a may query the social pay database 1003b for social pay rules, e.g., 1029. For example, the social payment server 1003a may issue PHP/SQL commands to query a database table for the social pay rules 1030. An example pay rules query 1029, substantially in the form of PHP/SQL commands, is provided below:

```
<?PHP
header(′Content-Type: text/plain′);
mysql_connect(“254.93.179.112”,$DBserver,$password);
  // access database server
mysql_select_db(“SocialPay_DB.SQL”); // select database table to search
//create query
$query = “SELECT rule_id rule_type rule_
description rule_priority rule_source
  FROM SocialPayRulesTable WHERE rule_type LIKE pay_rules”;
$result = mysql_query($query); // perform the search query
mysql_close(“SocialPay_DB.SQL”); // close database access
?>
```

In some embodiments, the social payment server 1003a may process the user social data using the social pay rules to identify pay commands, pay requests, merchant offers, and/or like content of the user social data. In some embodiments, rules may be provided by the social payment controller to ensure the privacy and security of the user's social data and virtual wallet. As another example, the rules may include procedures to detect fraudulent transaction attempts, and request user verification before proceeding, or cancel the transaction request entirely. In some embodiments, the social payment server may utilize a wallet security and settings component.

With reference to FIG. 10C, in some embodiments, the social payment server 1003a may optionally determine that, based on processing of the rules, user verification is needed to process a transaction indicated in a pay command. For example, if the rules processing indicated that there is a probability of the pay command being an attempt at a fraudulent transaction attempt, the social payment server 1003a may determine that the user 1001 must be contacted for payment verification before the transaction can be processed. In such scenarios, the social payment server 1003a may provide a pay command verification request 1033 to the client 1002a, which the client may display, e.g., 1034, to the user 1001. For example, the social payment server 1003a may provide a pay command verification request to the client 1002a as a HTTP(S) POST message including XML-formatted data. An example listing of a pay command verification request 1033, substantially in the form of a HTTP(S) POST message including XML-formatted data, is provided below:

```
POST /verifyrequest.php HTTP/1.1
Host: www.client.com
Content-Type: Application/XML
Content-Length: 256
<?XML version = “1.0” encoding = “UTF-8”?>
<verify_request>
  <transaction_ID>AE1234</transaction_ID>
  <timestamp>2011-02-02 03:04:05</timestamp>
  <amount>50000 vpts</amount>
  <message_string>5000000 vpts @jfdoe #thx</message_string>
</verify_request>
```

In some embodiments, the user 1001 may provide a verification input 1035 into the client, which may provide a pay command verification response 1036 to the social payment server 1003a. The social payment server 1003a may determine whether the payer verified payment, whether payee information available is sufficient to process the transaction, and/or the like. In scenarios where sufficient payee information is unavailable, the social payment server 1003a may optionally provide a social post message 1038 to a social networking service associated with the potential payee requesting the payee to enroll in social pay service, which the social network server 1004a may post 1039 for the payee. If all the requirements are met for processing the transaction, the social payment server 1003a may generate a unique transaction trigger associated with the triggering social post message, e.g., 1037, and store a transaction trigger ID, triggering social post message, etc., for recordkeeping or analytics purposes, e.g., 1040.

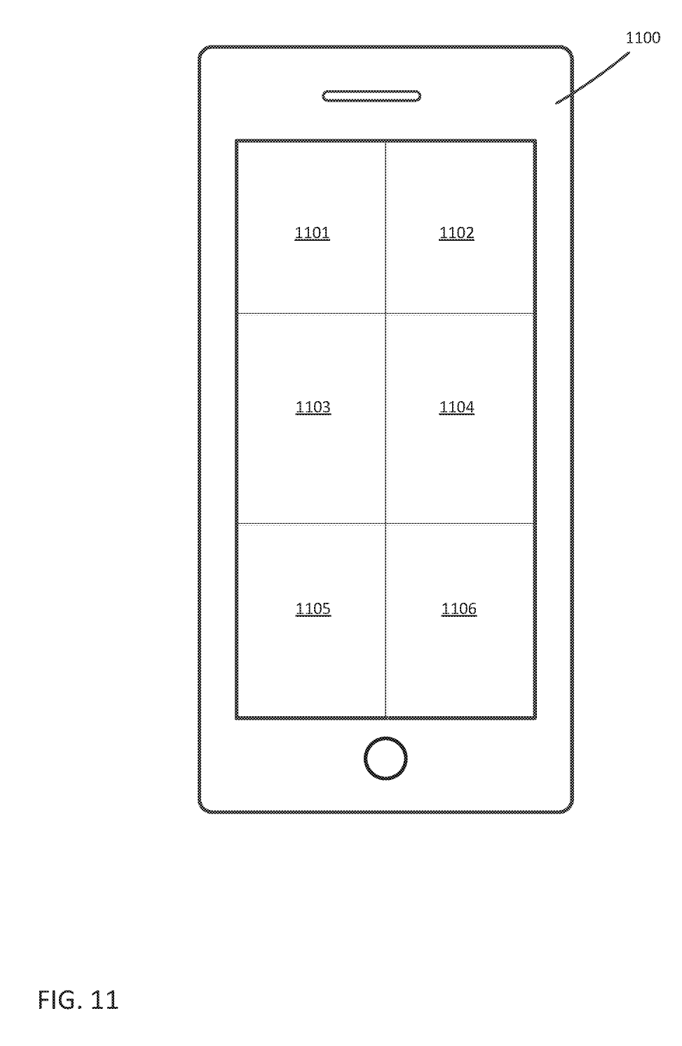

FIG. 11 shows an embodiment of a user interface diagram illustrating an overview of example features of virtual wallet applications in some embodiments of the social payment controller. FIG. 11 shows an illustration of various exemplary features of a virtual wallet mobile application 1100. Some of the features displayed include a wallet 1101, social integration via TWITTER, FACEBOOK, etc., offers and loyalty 1103, snap mobile purchase 1104, alerts 1105 and security, setting and analytics 1106.

In order to address various issues and advance the art, the entirety of this application for SOCIAL MEDIA PAYMENT PLATFORM APPARATUSES, METHODS AND SYSTEMS FOR PROCESSING PAYMENTS VIA SOCIAL MEDIA (including the Cover Page, Title, Headings, Field, Background, Summary, Brief Description of the Drawings, Detailed Description, Claims, Abstract, Figures, Appendices and/or otherwise) shows by way of illustration various embodiments in which the claimed innovations may be practiced. The advantages and features of the application are of a representative sample of embodiments only, and are not exhaustive and/or exclusive.

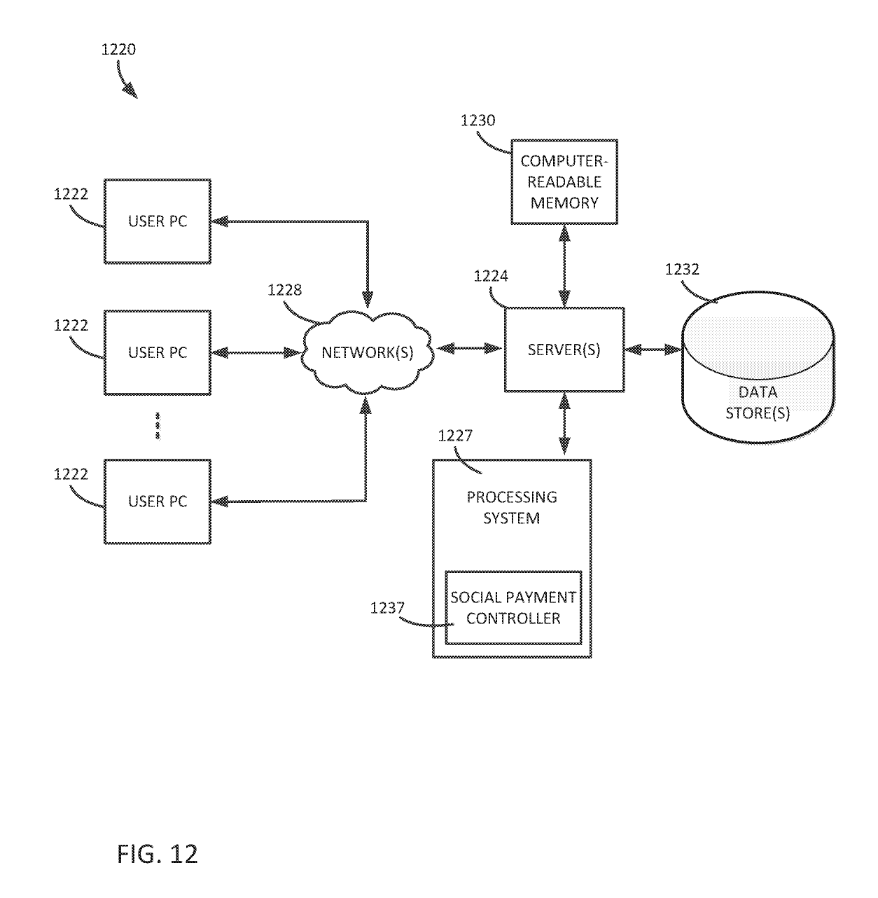

As an illustration, FIG. 12 depicts an embodiment of a system 1220 that includes a client-server architecture. One or more user PCs 1222 access one or more servers 1224 running an a social payment controller 1237 on a processing system 1227 via one or more networks 1228. The one or more servers 1224 may access a computer-readable memory 1230 as well as one or more data stores 1232. Computer readable memories (e.g., at 1230) or data stores (e.g., at 1232) may include one or more data structures for storing and associating various data used in the example systems. For example, a data structure stored in any of the aforementioned locations may be used to store data including user preferences, etc.

Each of the element managers, real-time data buffer, conveyors, file input processor, database index shared access memory loader, reference data buffer and data managers may include a software application stored in one or more of the disk drives connected to the disk controller, the ROM and/or the RAM. The processor may access one or more components as required.

A display interface may permit information from the bus to be displayed on a display in audio, graphic, or alphanumeric format. Communication with external devices may optionally occur using various communication ports.

In addition to these computer-type components, the hardware may also include data input devices, such as a keyboard, or other input device, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand. While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure.

They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SocialPay individual and/or enterprise user, database configuration and/or relational model, data type, data transmission and/or network framework, syntax structure, and/or the like, various embodiments of the social payment controller may be implemented that enable a great deal of flexibility and customization. For example, aspects of the social payment controller may be adapted for communication platforms, resource allocation systems, and/or the like. While various embodiments and discussions of the social payment controller have been directed to e-commerce, however, it is to be understood that the embodiments described herein may be readily configured and/or customized for a wide variety of other applications and/or implementations.

What is claimed is:

1. A computer-implemented method for processing payment requests via social media, the method comprising:
receiving, via a digital communication network, a payment request including payer information associated with a payer and payee information associated with a payee, the payment request being initiated by the payer and communicated via a social media network;
determining, via one or more processors, that the payer information is valid;
generating an intent-to-pay notice associated with the payment request;
transmitting, via a payment network, the intent-to-pay notice to a payee server associated with the payee based on the payee information;
receiving, via the payment network, a payment information request from the payee server, the payment information request including information associated with the intent-to-pay notice; and
in response to the payment information request, transmitting, via the payment network, payment information to the payee server, wherein the payment information allows the payee to process a payment associated with the payment request.

2. The method of claim 1, wherein the payer is associated with a social network account with the social media network, and wherein the payment request is received based on information associated with the social media account.

3. The method of claim 1, further comprising verifying, via the one or more processors, that the payee is registered to receive payments initiated through the social media network by comparing the payee information with a pre-determined list of registered payee information.

4. The method of claim 1, wherein the payment information is a payment token provided in lieu of the payer's actual payment information.

5. The method of claim 4, wherein the payment token is configured to expire after processing the payment request.

6. The method of claim 1, further comprising transmitting, via the digital communication network, first confirmation information to the payee via the digital communication network.

7. The method of claim 6, wherein the payment information request includes second confirmation information.

8. The method of claim 7, further comprising determining, via the one or more processors, that the first confirmation information matches the second confirmation information.

9. The method of claim 6, wherein the payer has a social media account with the social media network, and wherein the confirmation information is transmitted using information associated with the social media account.

10. A computer-implemented method for processing payment requests via social media, the method comprising:
receiving, via a digital communication network, a payment request including payer information associated with a payer and payee information associated with a payee, the payment request being initiated by the payer and communicated via a social media network;
determining, via one or more processors, that the payer information is valid;
transmitting, via the digital communication network, first confirmation information to a computing device associated with the payer;
receiving, via a payment network, a payment information request from a payee server associated with the payee, the payment information request including second confirmation information;
determining, via the one or more processors, that the first confirmation information matches the second confirmation information; and
based on the determination that the first confirmation information matches the second confirmation information, transmitting, via the payment network, payment information to the payee server, wherein the payment information allows the payee to process a payment associated with the payment request.

11. The method of claim 10, wherein the payer is associated with a social network account with the social media network, and wherein the payment request is received based on information associated with the social media account.

12. The method of claim 10, further comprising verifying, via the one or more processors, that the payee is registered to receive payments initiated through the social media network by comparing the payee information with a pre-determined list of registered payee information.

13. The method of claim 10, wherein the payer has a social media account with the social media network, and wherein the confirmation information is transmitted using information associated with the social media account.

14. The method of claim 10, wherein the payment information is a payment token provided in lieu of the payer's actual payment information.

15. The method of claim 14, wherein the payment token is configured to expire after processing the payment request.
